(19) United States
(12) Patent Application Publication
(10) Pub. No.: US 2012/0070020 A1
(43) Pub. Date: Mar. 22, 2012

(54) SPEAKER DEVICE, AUDIO CONTROL DEVICE, WALL ATTACHED WITH SPEAKER DEVICE

(76) Inventor: Hiroyuki Kano, Hyogo (JP)

(21) Appl. No.: 13/321,858

(22) PCT Filed: Mar. 24, 2011
(86) PCT No.: PCT/JP2011/001736

§ 371 Date: Nov. 22, 2011

(30) Foreign Application Priority Data
Mar. 26, 2010 (JP) 2010073830

(51) Int. Cl. H04R 1/02; H04R 3/00

(52) U.S. Cl. 381/122; 381/386

(57) ABSTRACT

A speaker (10) includes: a speaker unit (20); a passive radiator (50x) in front of the speaker unit (20); and a cabinet (30) storing the speaker unit (20) to cover a rear space behind the speaker unit (20) to seal a space (30x) between the speaker unit (20) and the passive radiator (50x). An effective piston area (50L) of the passive radiator (50x) is larger than an effective piston area (20L) of the speaker unit (20).

### TECHNICAL FIELD

The present invention relates to sound control systems, and more particularly to a sound control system including a speaker having a size allowing the speaker to be embedded in a wall or partition in order to reduce noise and improve music effects (such as sound reality and sound quality). Further particularly, the present invention relates to a sound control system having acoustic and electrical innovation to control sound in just front of the speaker and achieve a small arithmetic operation amount even if the entire wall or partition is controlled, so that a wide control area surrounded by the wall or partition can be ensured with less arithmetic operation load.

### BACKGROUND ART

For example, in order to reduce uncomfortable noise, there have conventionally been conceived techniques of reproducing anti-phase sound by a control speaker to cancel noise, namely, techniques of active noise control. In a limited one-dimensional space having a relatively small space size, such as a headphone or a duct (pipe line), the active noise control techniques have been effective. Control methods used in the active noise control techniques have been performed by digital fashion as well as analog fashion in the one-dimensional space. In other words, in the one-dimensional space, the control can be achieved with relatively less arithmetic operation and therefore the control methods by digital fashion can be performed with low cost. Therefore, the conventional active noise control techniques have been applied in one-dimensional spaces.

However, in a three-dimensional space having a large space size, such as a general home room, an office, or a vehicle interior, it is necessary to provide a large number of control points to achieve the above-described effects. In other words, without a large number of control points, it is impossible to offer desired effects in such a wide area. As a result, the provision of the large number of control points increases an arithmetic operation amount and therefore fails to achieve low cost.

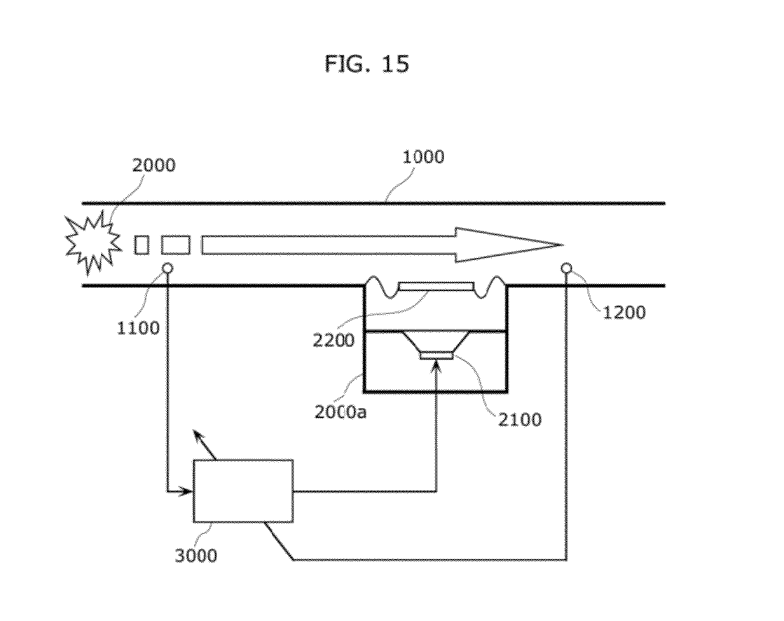

FIG. 15 is a diagram showing a first conventional art of the active noise control in a one-dimensional space (hereinafter, referred to also as “one-dimensional control”), which is disclosed in Japanese Unexamined Patent Application Publications Nos. 7-77991 (hereinafter, referred to also as “Patent Reference 2”) and 8-19083 (hereinafter, referred to also as “Patent Reference 3”).

In the example shown in FIG. 15, a noise source 2000 having a heat source exists upstream of a duct 10000. The noise source 2000 emits high-temperature gas as well as noise which are exhausted downstream in the duct 1000.

In an active noise sound control system disclosed in the first conventional art, a noise microphone 1100 provided upstream in the duct 1000 detects the noise generated by the noise source 2000, and then a control filter 3000 processes signal of the detection and provides the resulting signal to a speaker unit 2100.

The speaker unit 2100 is equipped to a cabinet 2000a. More specifically, the rear side of the speaker unit 2100 hermetically seals the cabinet 2000a. Thereby, the speaker unit 2100 reproduces control signals provided from the control filter 3000. An example of the speaker unit 2100 is a driver.

Then, in front of the speaker unit 2100, a passive radiator 2200 is provided to the cabinet 2000a to form a sealed space in the cabinet 2000a. The passive radiator 2200 has a circumference edge attached to the cabinet 200a, so that the passive radiator 2200 can be moved. As a result, controlled sound reproduced by the speaker unit 2100 is propagated into the duct 1000 via the passive radiator 2200.

The control sound propagated into the duct 1000 interferes with the noise emitted from the noise source 2000 to generate interfering sound. The interfering sound is detected by an error microphone 1200 in downstream of the duct 1000 to be provided to a control filter 3000.

The control filter 3000 varies its filter characteristics to minimize the signal detected by the error microphone 1200. For a control algorithm used in the above control, Filtered-X LMS (ADAPTIVE SIGNAL PROCESSING (Bernard Widrow & Samuel D. Stearns, PRENTICE-HALL INC., pp. 288-292, hereinafter, referred to also as “Non-Patent Reference 1”) is generally used.

As a result, the error microphone 1200 provided at the above-described position can reduce the noise.

Here, the inside of the duct 1000 is a non-dimensional space, because a cross-sectional area of the duct 1000 is small enough for noise to be controlled. Therefore, if the error microphone 1200 can reduce noise, the same sound control effects (namely, noise reduction effects) can be offered wherever in the duct 1000 downstream from the error microphone 1200.

Moreover, the provision of the passive radiator 2200 having relatively high heat resistance and corrosion resistance can prevent the speaker unit 2100 from being heated and corroding.

As described above, in the first conventional art shown in FIG. 15, noise can be controlled in a one-dimensional space such as the duct 1000. However, the first conventional art cannot be directly applied to a three-dimensional space such as a residential space.

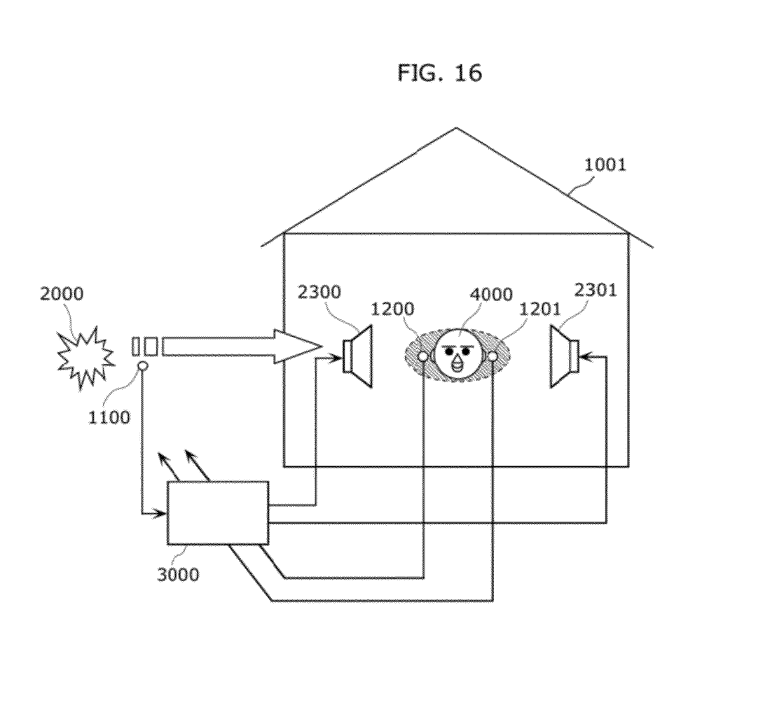

FIG. 16 is a diagram showing another configuration of the first conventional art.

Control is performed as shown in FIG. 16. In this control, the above-described Filtered-X LMS is converted for multi-channel application to be applied in three-dimensional noise control. An example of this control is disclosed in “ACTIVE CONTROL OF SOUND” P. A. Nelson & S. J. Elliott, ACADEMIC PRESS, pp. 397-410, hereinafter, referred to also as “Non-Patent Reference 2”).

As shown in FIG. 16, noise is emitted from a noise source 2000 outside a house 1001 and the noise enters the house 1001. The noise is reduced near a person 4000 in the house 1001.

A noise microphone 1100 detects the noise emitted from the noise source 2000 as noise signal. The noise signal is provided to a control filter 3000. The control filter 3000 performs predetermined signal processing on the noise signal and provides the resulting signal to speakers 2300 and 2301.

Here, each of the speakers 2300 and 2301 is a speaker system in which a speaker unit is equipped to a cabinet. The speakers are commonly called sealed speakers or bass reflex speakers. An example of the speaker unit is a driver.

As a result, each of the speakers 2300 and 2301 reproduces controlled sound, and each of error microphones 1200 and 1201, which are provided near ears of the person 4000, detects a result that the controlled sound interferes with the noise entering the house.

The control filter 3000 varies its filter characteristics to minimize signals of the detection of the error microphones 1200 and 1201. As a result, the error microphones 1200 and 1201 reduce the noise.

Meanwhile, the person 4000 can perceive the noise reduction when the noise is controlled at least near both ears of the person 4000. Therefore, the error microphones 1200 and 1201 are provided near the ears. In consideration of the situation where the person 4000 moves, it is desirable that a control area (region surrounded by a broken line in the figure) is set to surround a head of the person 4000, and a plurality of error microphones are provided to surround the control area as needed.

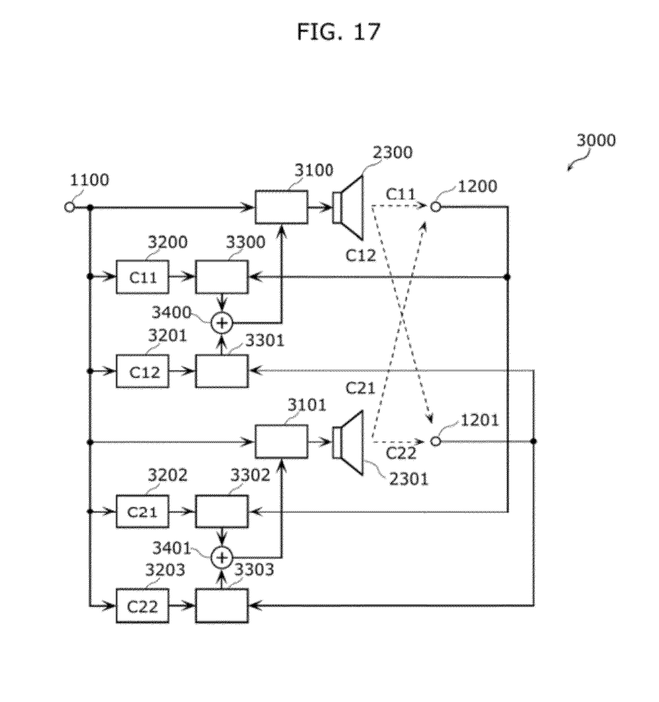

FIG. 17 is a diagram showing an internal structure of the control filter shown in FIG. 16.

The following describes the structure of the control filter 3000 performing the three-dimensional noise control in detail with reference to FIG. 17.

The control filter 3000 includes Finite Impulse Response (FIR) filters 3100 and 3101, Fx filters 3200 to 3203, Least Mean Square (LMS) calculators 3300 to 3303, and coefficient adders 3400 and 3401.

The FIR filter 3100 performs convolution on noise signal provided from the noise microphone 1100 (shown in FIG. 16) and a corresponding coefficient to generate control signal, and provides the control signal to the speaker 2300. Likewise, the FIR filter 3101 performs convolution on the noise signal provided from the noise microphone 1100 (shown in FIG. 16) and a corresponding coefficient to generate control signal, and provides the control signal to the speaker 2301.

The Fx filter 3200 has a coefficient generated by approximating propagation characteristics C11 regarding propagation from the speaker 2300 to the error microphone 1200. The Fx filter 3201 has a coefficient generated by approximating propagation characteristics C12 regarding propagation from the speaker 2300 to the error microphone 1201. The Fx filter 3202 has a coefficient generated by approximating propagation characteristics C21 regarding propagation from the speaker 2301 to the error microphone 1201. The Fx filter 3203 has a coefficient generated by approximating propagation characteristics C22 regarding propagation from the speaker 2301 to the error microphone 1200. Each of the Fx filters 3200 to 3203 performs convolution on the noise signal provided from the noise microphone 1100 and the corresponding coefficient. The Fx filters 3200 to 3203 provide the respective convolution results to the LMS calculators 3300 to 3303, respectively.

The LMS calculators 3300 and 3302 receive detection signal from the error microphone 1200, and the LMS calculators 3301 and 3303 receive detection signal from the error microphone 1201. Each of the LMS calculators 3300 to 3303 performs LMS arithmetic operation on the received corresponding detection result with reference to error signal and the signal provided from the corresponding one of the Fx filters 3200 to 3203.

Then, the coefficient adder 3400 adds the LMS arithmetic operation results of the LMS calculators 3300 and 3301 to update the coefficient of the FIR filter 3100. Likewise, the coefficient adder 3401 adds the LMS arithmetic operation results of the LMS calculators 3302 and 3303 to update the coefficient of the FIR filter 3101.

A sequence of the generation of the control signals in the FIR filters 3100 and 3101 and the updating of the coefficients is repeated to reduce noise by the error microphones 1200 and 1201 at two control points by using the two speakers 2300 and 2301.

As described above, the first conventional art achieves noise reduction control in a three-dimensional space. However, it is necessary to provide a large number of the speakers and error microphones around the control area covering the entire house 1001 where the person 4000 can perceive the noise reduction wherever in the house 1001.

The increase of the speakers and error microphones also increases the FIR filters, Fx filters, and LMS calculators shown in FIG. 17. Especially, each of the number of Fx filters and the number of the LMS calculators is calculated by multiplying the number of the speakers by the number of the error microphones. Therefore, as the control area is enlarged, an arithmetic operation amount of the control filter 300 is increased in an exponential fashion. In the example shown in FIG. 17, the number of the speakers (the speakers 2300 and 2301) is two, and the number of the microphones (the error microphones 1200 and 1201) is also two.

Japanese Unexamined Patent Application Publication. No. 10-177391 (hereinafter, referred to also as “Patent Reference 1”) or the like discloses a technique of reducing the arithmetic operation amount even if the control area is enlarged.

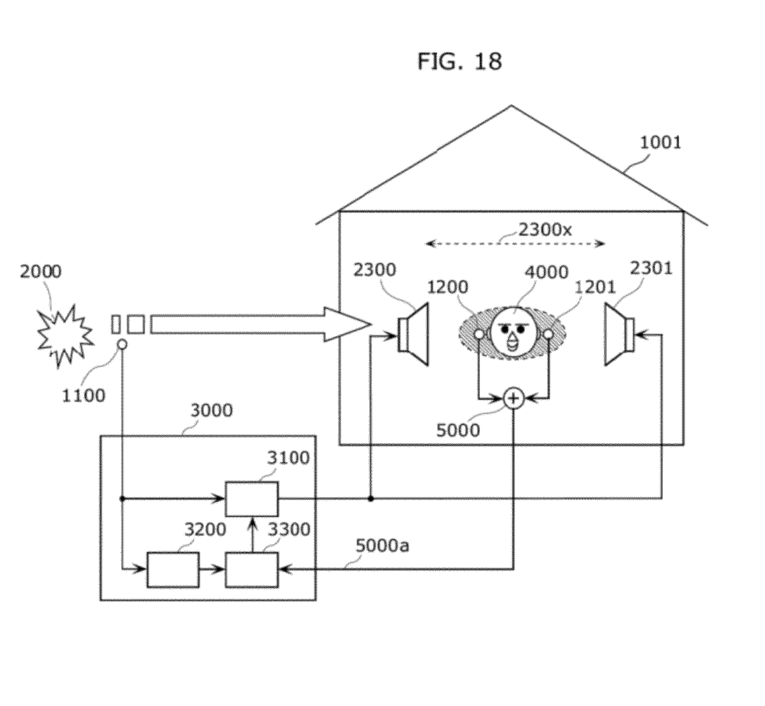

FIG. 18 is a diagram showing a second conventional art in which the technique disclosed in Japanese Unexamined Patent Application Publication No. 10-177391 is applied in the situation of FIG. 16 for comparison.

Japanese Unexamined Patent Application Publication No. 10-177391 discloses an application in the situation where a noise source is inside a house. However, the Claims in the patent publication does not restrict that the noise source is inside a house. In other words, the patent publication is characterized in that detection signals generated by a plurality of error microphones which are provided at control points rather than at the position of the noise source are added together. Therefore, FIG. 18 shows the situation where the noise source 2000 is outside the house 1001 likewise FIG. 16.

Noise emitted from the noise source 2000 which is detected by the noise microphone 1100 as noise signal is processed by the control filter 3000, and then the processed signal is reproduced as controlled sound by the speakers 2300 and 2301.

Each of the error microphones 1200 and 1201 provided near both ears of the person 4000 detects a result that the controlled sound interferes with the sound propagated from the outside. An adder 5000 add the respective detected results together to generate error signal 5000a and provides the error signal 5000a to the control filter 3000.

Here, the control filter 3000 includes a FIR filter 3100, a Fx filter 3200, and an LMS calculator 3300. The FIR filter 3100 performs convolution on the coefficient and the detection signal provided from the noise microphone 1100 to generate and output control signal.

The coefficient is newly determined by the LMS calculator based on the output of the Fx filter 3200 and the error signal provided from the adder 5000. The coefficient of the FIR filter 3100 is updated to the newly determined coefficient.

A sequence of the control signal generation and the coefficient updating is repeated to reduce error signal provided from the adder 5000.

In other words, the control shown in FIG. 18 is performed based on the Filtered-X LMS algorithm likewise the control shown in FIG. 15. Therefore, in the Fx filter 3200, propagation characteristics regarding propagation from the speakers 2300 and 2301 to the adder 5000 via the error microphones 1200 and 1201 are approximated as coefficients.

As described above, the control shown in FIG. 16 has an arithmetic operation, size as explained with reference to FIG. 17. However, the control shown in FIG. 18 has an arithmetic operation size of one fourth of that of FIG. 16 to achieve three-dimensional noise control around the head of the person 4000. However, the configuration shown in FIG. 18 can reduces the error signal 5000a provided from the adder 5000. The error signal 5000a is not the same as the detection signals provided from the error microphones 1200 and 1201 (namely, sound detected at a position of each of the error microphones 1200 and 1201).

The following describes, in more detail, a distance (see a distance 2300 x) between the position of the error microphone 1200 and the position of the error microphone 1201.

More specifically, at frequency (frequency having a long wavelength enough for a distance between the error microphones 1200 and 1201) by which the signal detected by the error microphone 1200 and the signal detected by the error microphone 1201 are in coordinate-phase relationship, if the adder 5000 adds these signals together, the signals emphasizes each other but do not cancel each other.

On the other hand, at frequency (frequency having a short wavelength for a distance between the error microphones 1200 and 1201) by which the signal detected by the error microphone 1200 and the signal detected by the error microphone 1201 are in an anti-phase relationship, if the adder 5000 adds these signals together, the signals cancel each other and eventually components of the frequency are lost due to the error signal.

Therefore, if the error signal does not including sound having the frequency although the sound exists near the ears of the person, it is difficult to control the sound.

Therefore, as shown in FIG. 18, in the configuration where error signals detected by the error microphones at the control point are added together, stable sound control (stable noise reduction) can be performed only when a frequency of detected sound is equal to or lower than a frequency enough for a distance between the error microphones in a coordinate-phase relationship (at least not in an anti-phase relationship).

Even if there are above-described conditions for controlling frequency, if the operation is performed under the conditions, the technique disclosed in Japanese Unexamined Patent Application Publication No. 10-177391 (Patent Reference 1) can serve as a means for reducing an arithmetic operation amount.

Japanese Unexamined Patent Application Publication No. 10-177391 (Patent Reference 1) discloses that the number of the error microphones may be two or more (for example, eight error microphones). If there are two or more error microphones, a distance between a pair from the error microphones is short, and a distance between another pair is long. As a result, the conditions for controlling frequency are complicated. In the above case, all signals of these error microphones are added together. Therefore, the conditions under which the stable operation can be surely performed are that the longest distance between a pair from the error microphones results in a frequency equal to or lower than the frequency considered as resulting in a coordinate-phase relationship of the signals of the pair. As a result, the conditions under which the stable operation can be performed become more stringent.

It should be noted that the technique disclosed in Patent Reference 4 is also referred to as needed. The following describes the technique disclosed in Patent Reference 4. An outer circumference part of a touch pad of an electronic device is supported by a case of the electronic device by using a suspension. As a result, there is a space for sound emission between the case and the touch pad. An electrical machine audio convertor emits sound into the space. If the sound is emitted, the touch pad is oscillated by energy of the emitted sound. As a result, the touch pad outputs the sound to the outside of the electric device.

### CONVENTIONAL ARTS

### Patent References

Patent Reference 1: Japanese Unexamined Patent Application Publication No. 10-177391
Patent Reference 2: Japanese Unexamined Patent Application Publication No. 7-77991
Patent Reference 3: Japanese Unexamined Patent Application Publication No. 8-19083
Patent Reference 4: Japanese Unexamined Patent Application Publication No. 2004-110800

### DISCLOSURE OF INVENTION

### Problems That Invention Is To Solve

Meanwhile, in the first conventional art, the controlled sound is emitted via the passive radiator 2200 (shown in FIG. 15) for the following reason.

In the duct 1000, the high-temperature gas flows. In general, a diaphragm made of pulp in the speaker unit 2100 and the edge made of resin have low heat resistance and low corrosion resistance. If such diaphragm and edge contact directly the high-temperature gas, they are burned or corrode. In order to address the problem, the passive radiator 2200 made of a material having high heat resistance and high corrosion resistance is provided to prevent deterioration of performance and quality of the speaker unit 2100.

As described above, the passive radiator 2200 is provided to prevent the speaker unit 2100 from high temperature and corroding, and not to improve noise reduction effects.

More specifically, if gas with noise flowing in the duct 1000 has a high temperature, it is not necessary to provide the passive radiator 2200 and it is possible to equip the speaker unit 2100 directly to the duct 1000 without any problems.

Here, if the diaphragm of the passive radiator 2200 is made of a metal to increase heat resistance and corrosion resistance, the diaphragm is heavy and hard. Therefore, the following various drawbacks occur. For example, due to decrease of performance efficiency, necessary sound pressure is not ensured. Lack of an appropriately internal loss increases a resonant frequency which makes it difficult to output low-pitched sound. Or, sharp resonant characteristics often occur and the sound pressure frequency characteristics are not smooth.

Likewise, if the edge of the passive radiator 2200 is made of a metal or resin as film processing, the edge is hardened and the diaphragm is difficult to move. As a result, there is a drawback that low-pitched sound necessary for the noise control is not reproduced with enough sound pressure, for example.

Next, in the technique of the second conventional art (shown in FIG. 18), the noise control is possible even in a three-dimensional space while suppressing an arithmetic operation amount. However, as described earlier, a target to be controlled (upper-limit frequency or the control area) is restricted depending on a distance between the error microphones (the error microphones 1200 and 1201 in FIG. 18) which output error signals to be added together. Therefore, it is difficult to produce the sound control effects (namely, noise reduction effects) in a wide space such as an entire room in the house 1001. In other words, if it is desired to produce the control effects at a relatively large number of positions in a room in the house 1001, the above-described distance (distance 2300x) is relatively long. Therefore, a range of frequency having anti-phase in the distance is enlarged, so that (appropriate) control effects cannot be obtained.

Japanese Unexamined Patent Application Publication No. 10-177391 (Patent Reference 1) discloses that the speakers and the error microphones are arranged to satisfy a 1-to-1 relationship between a speaker and an error microphone (the number of the speakers is equal to the number of the error microphones). However, Patent Reference 1 does not disclose a relatively appropriate positional relationship among the positions of the speakers and the error microphones (for example, a distance between a speaker and a error microphone).

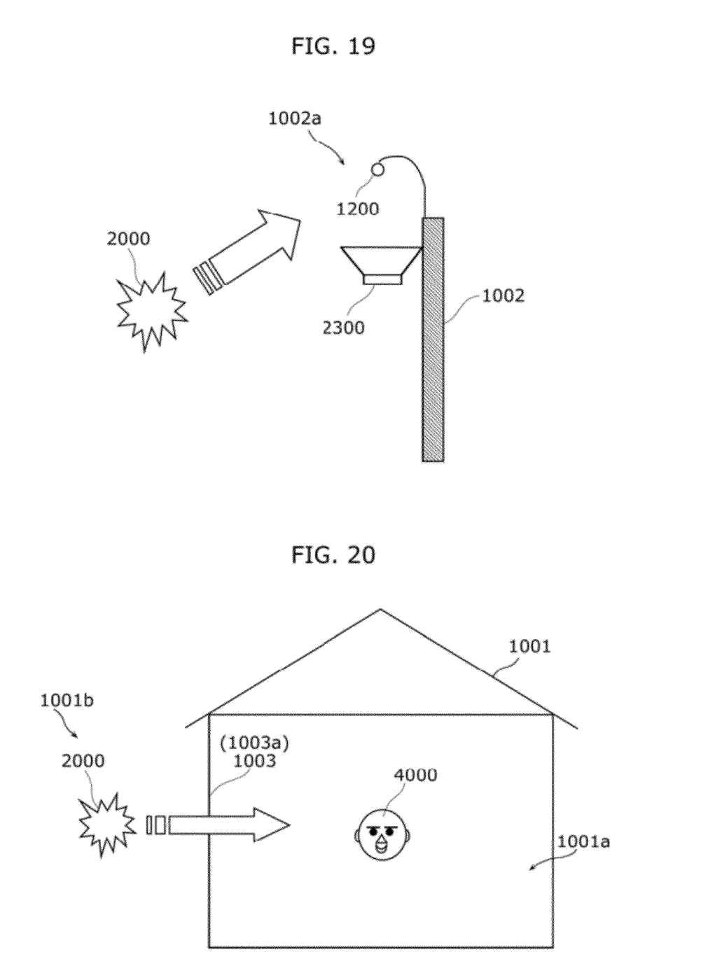

Patent Reference 1 merely discloses in detail as shown in FIG. 19 that the speaker 2300 is provided to the noise source 2000 side of an edge (edge 1002a) of the partition 1002, and the error microphone 1200 is also provided to the edge 1002a. However, Patent Reference does not disclose, even regarding the above structure, that a distance between the speaker 2300 and the error microphone 1200 influences the sound control effects (noise reduction effects). In other words, Patent Reference 1 does not focus on whether or not a preferable distance between the speaker 2300 and the error microphone 1200 is relatively short or long. In short, Patent Reference 1 does not disclose a preferable distance between the speaker 2300 and the error microphone 1200.

Moreover, although Patent Reference 1 discloses that the speaker is equipped in the wall (partition), it does not disclose exactly where the error microphone is equipped.

More specifically, Patent Reference 1 fails to disclose the influence of the positional relationship between the speaker and the error microphone to the sound control effects (noise reduction effects). Especially, Patent Reference 1 fails to disclose a problem caused by a short distance between the speaker and the error microphone and a solution of the problem.

The present invention is provided to control a sound field, so that noise from the outside (outside of a house or a next-door room in the house) is reduced in an entire space to be controlled, such as a residential area including a home or an office, or that all family members watching TV or listening music in a listening room can enjoy the same good quality audio effects.

In order to achieve the above, it is necessary to provide a large number of speakers and corresponding error microphones to over an area as wide as possible.

On the other hand, the speakers and the error microphones should be arranged not to obstruct a path of a person moving around the room. Therefore, it is ideal that the speakers and the microphones are provided in a wall in the space to be controlled.

FIG. 20 is a diagram showing a situation example where sound emitted from a noise source 2000 enters an area (the to-be-controlled space 1001a) via a wall 1003 if the noise source 2000 is outside (space 1001b) the house 1001.

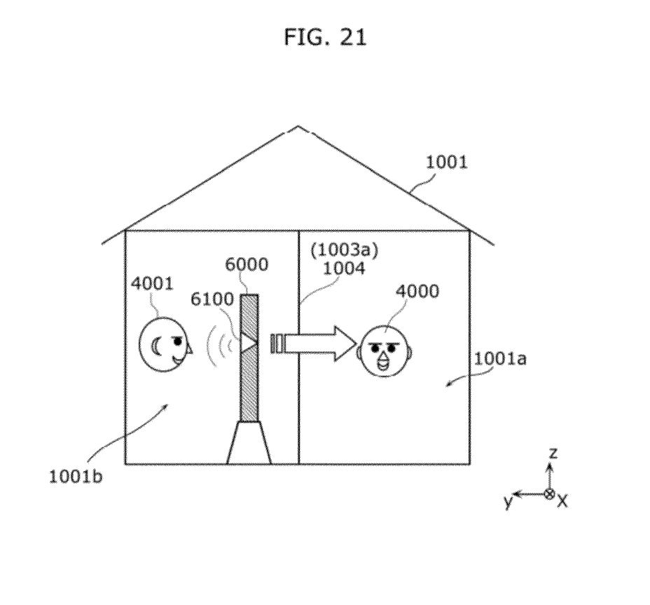

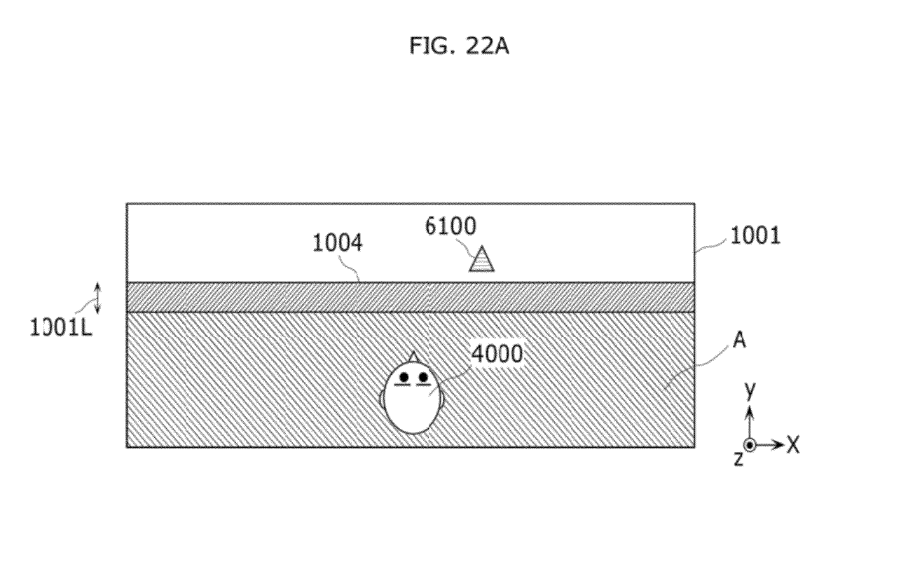

FIG. 21 is a diagram showing a situation example where a person 4001 watches a TV 6000 having a speaker 6100 in a room (space 1001b) in the same house 1001 and therefore sound emitted from the speaker 6100 enters a next-door room (a to-be-controlled space 1001a) via a wall 1004.

In both cases in FIGS. 20 and 21, the space (room) where the person 4000 exists is the to-be-controlled space 1001a which is to be quiet. In both cases, sound enters the to-be-controlled space 1001a via the wall 1003 or 1004. If noise entering from the wall 1003 or 1004 (wall 1003a) can be blocked, it would be possible to reduce the noise in the entire to-be-controlled space 1001a where the person 4000 exists.

Here, an area of the wall 1003 or 1004 blocking the noise is varied to compare resulting noise reduction amounts in the to-be-controlled space by using audio simulation.

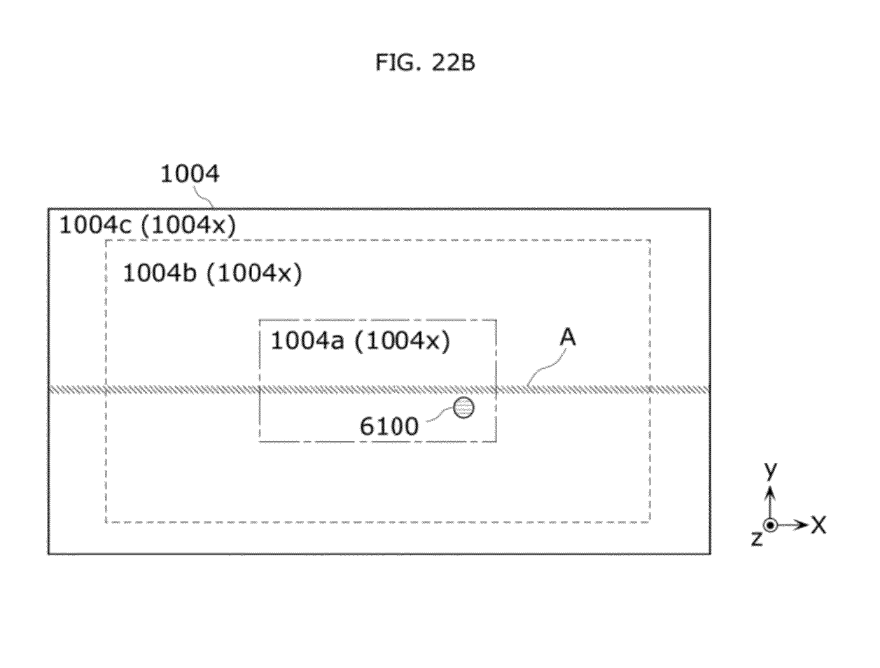

Each of FIGS. 22A and 22B is a diagram showing an analysis model based on the situation in FIG. 21.

FIG. 22A is a top view of the house 101 (a horizontal to vertical ratio of the figure has no significance). FIG. 22A shows the wall 1004 viewed from the to-be-controlled space.

A difference between (a) sound pressure distribution in the to-be-controlled space in the case where the speaker 6100 in the TV emits noise and (b) sound pressure distribution in the to-be-controlled space in the case where the noise propagated via the wall 1004 is blocked by a predetermined amount is determined as a noise reduction amount.

Here, as shown in FIG. 22B, noise reduction amounts in the following situations are compared to one another: (a) the situation where a blocking region 1004x in which the noise is to be clocked is a relatively small region 1004a surrounded by a chain line in the wall 1004, (b) the situation where the blocking region 1004x is a relatively large region 1004b surrounded by a dotted line in the wall 1004, and (c) the situation where the blocking region 1004x is an entire region (region 1004c) of the wall 1004 surrounded by a solid line.

Here, an analysis plane where a noise reduction amount is analyzed is a plane A (shown by hatching) in each of FIGS. 22A and 22B.

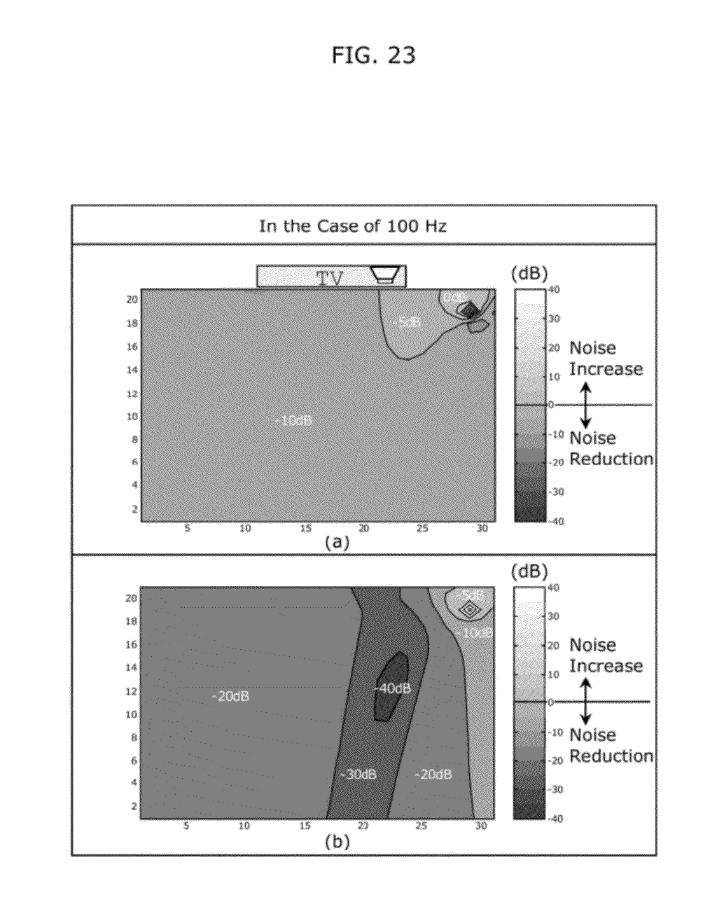

Each of FIGS. 23 to 26 shows analysis results of the analysis of FIGS. 22A and 22B.

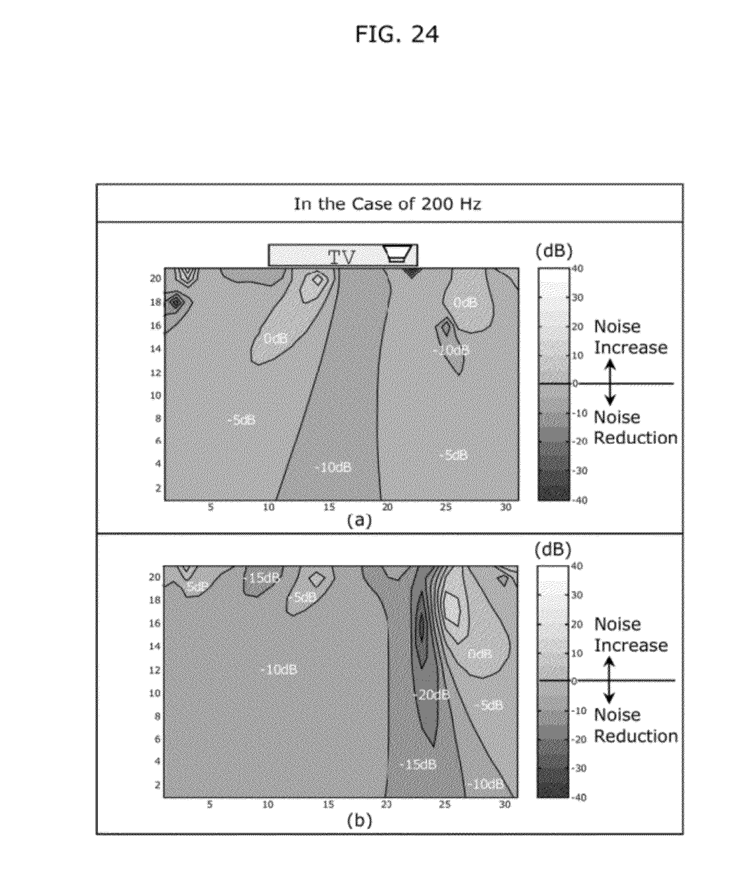

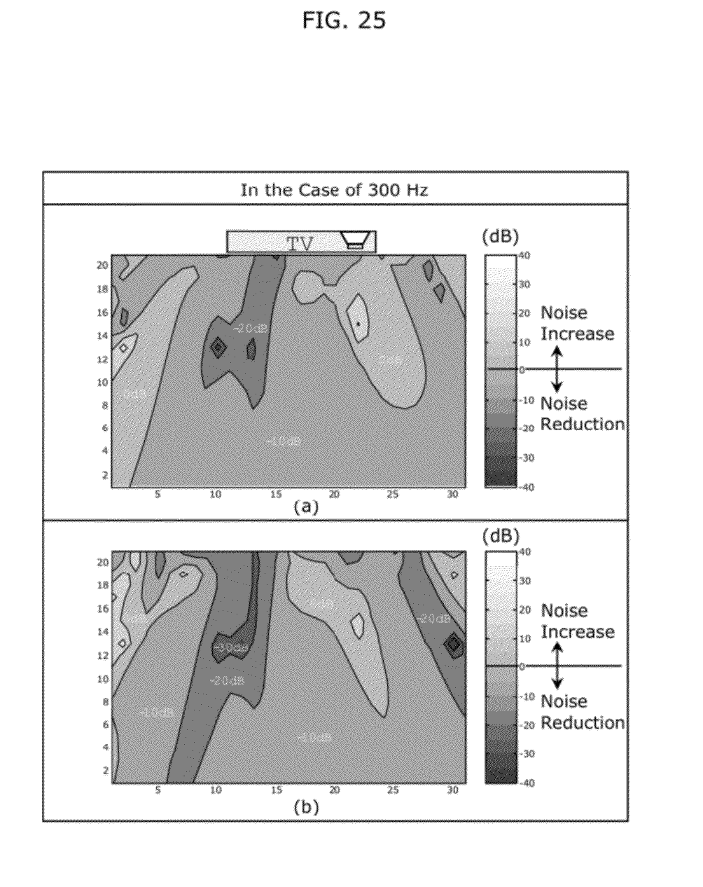

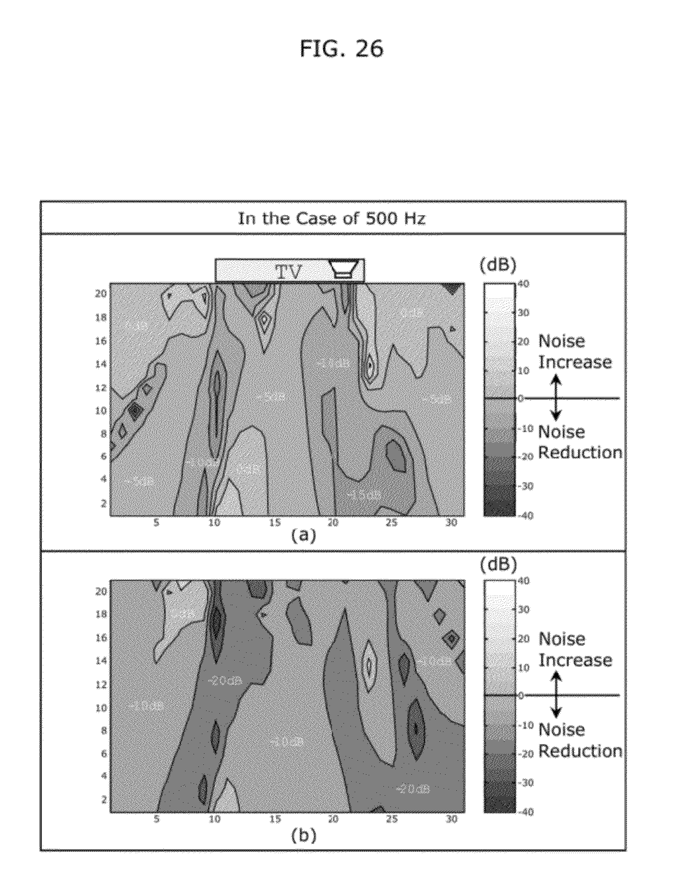

FIG. 23 shows sound pressure distribution in the case of frequency of 100 Hz. FIG. 24 shows sound pressure distribution in the case of frequency of 200 Hz. FIG. 25 shows sound pressure distribution in the case of frequency of 300 Hz. FIG. 26 shows sound pressure distribution in the case of frequency of 500 Hz.

A graph (a) in each of FIGS. 23 to 26 shows the situation where noise is blocked by 20 dB by the region 1004a (the small area) surrounded by the chain line in FIG. 22B. A graph (b) in each of FIGS. 23 to 26 shows the situation where noise is blocked by 20 dB by the region 1004b (the middle area) surrounded by the dotted line in FIG. 22B

The sound pressure distribution in each of the graphs (a) and (b) shows a sound pressure after noise blocking, under assumption that a sound pressure before the noise blocking is 0 dB. More specifically, minus indication (such as −20 dB) means noise reduction, and darker indication means higher noise reduction effects (white numeral values are added to clarify the noise reduction effects).

As shown in the FIGS. 23 to 26, the graph (b) shows greater noise reduction effects in a wider range at any frequency.

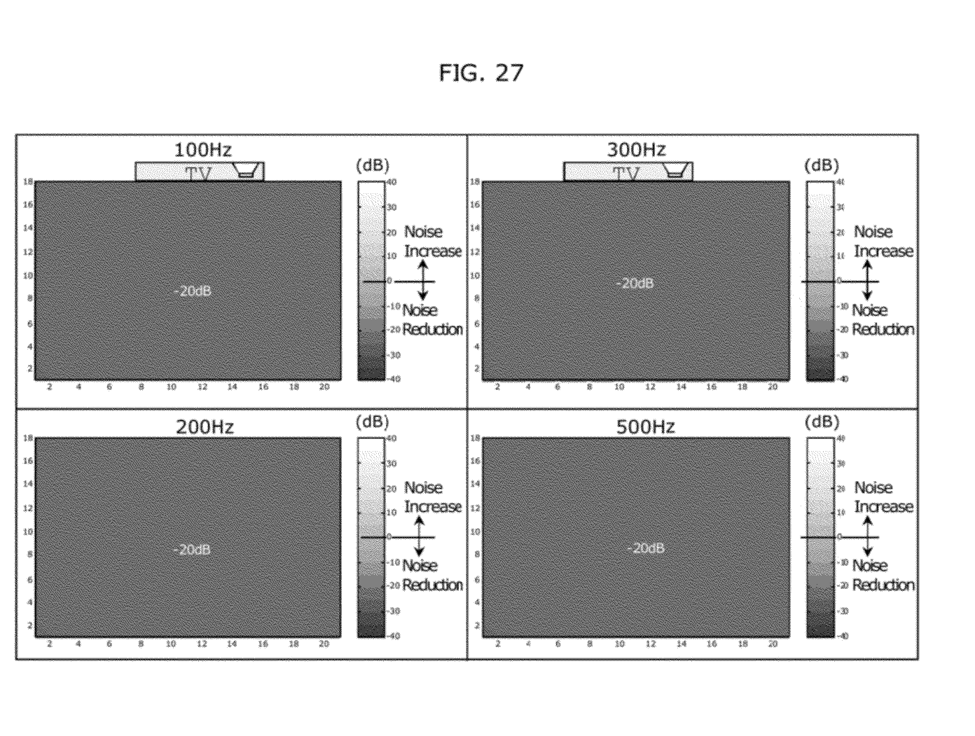

FIG. 27 shows graphs each plotting the situation where the noise is blocked by the entire wall 1004 (the large region 1004c) by 20 dB.

As a matter of course, noise reduction effects by 20 dB are produced in the entire space to be controlled at any frequency.

As obvious from the above results, in order to produce noise reduction effects in the widest region in the space to be controlled, it is necessary to homogenously control noise by a surface as wide as possible (ideally, the entire surface) of the wall from which the noise enters.

Therefore, as described earlier, it is conceived a method of reducing noise by a wall via which noise is propagated, by using a relatively large number of speakers equipped in the wall and error microphones each of which is very close to a corresponding one of the speakers.

However, the method has some problems.

The first problem is that as the noise reduction amount and the noise reduced area are increased, the number of the speakers and the number of the error microphones are also increased. As a result, an arithmetic control amount is huge.

The second problem is that, if each speaker is embedded in a wall, as a thickness of the speaker is increased, a total thickness of the wall including the speaker is also increased (see a thickness 1001L in FIG. 22), or the speaker cannot be embedded in a common-sized wall. The second problem results in narrowing the target room. In addition, a speaker having a great thickness generally increases a horizontal and vertical size of the speaker and eventually increases its weight. If a large number of such heavy speakers are equipped in the wall, a strength of the wall is to be considered.

The third problem is that, if each error microphone is provided very close to a corresponding speaker, sound emitted from the speaker has a spherical waveform not a planar waveform. In such a spherical waveform, the wave field is not steady near the center of the speaker and at the vicinity of the speaker, for example. Therefore, if the error microphone is positioned near the center of the speaker, the noise reduction effects can be obtained at the position, but are deteriorated at other positions out of the position. The problem is described in more detail below.

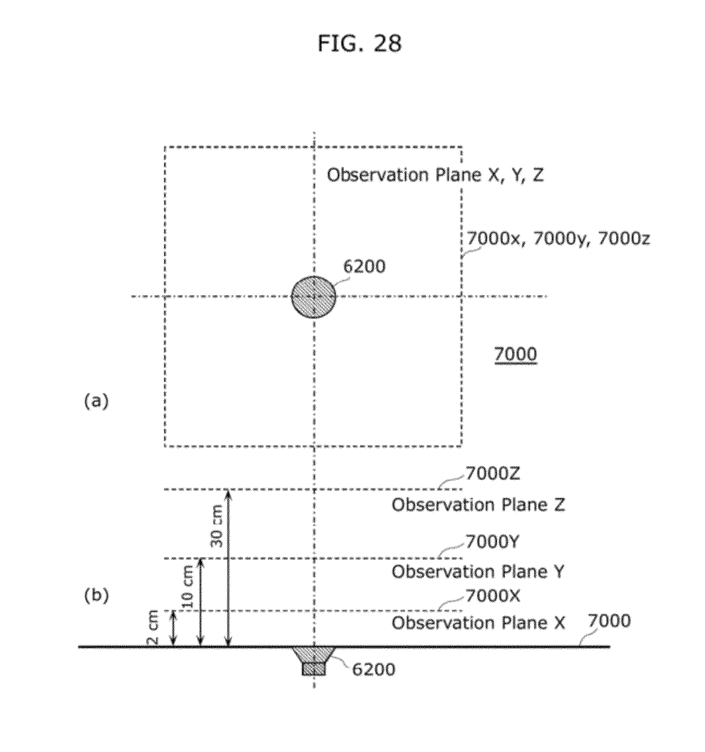

FIG. 28 is a diagram showing an audio simulation model for comparing various sound pressure distribution of sound emitted from a speaker unit 6200 depending on a distance between a target observation plane and the speaker unit 6200. The speaker unit 6200 has a diameter (interior diameter) of 5 cm and is equipped to an infinite baffle 700.

In FIG. 28, (b) shows a side view, assuming that an observation plane X is far from the speaker unit 6200 by 2 cm, an observation plane Y is far from the speaker unit 6200 by 10 cm, and an observation plane Z is far from the speaker unit 6200 by 30 cm.

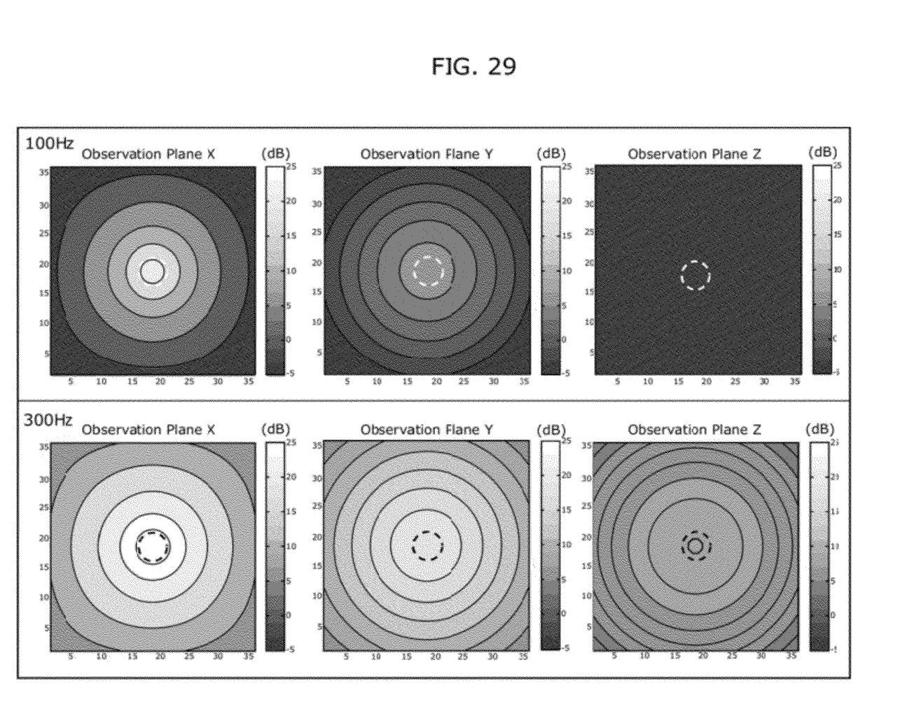

FIG. 29 shows results of the analysis in FIG. 28.

In FIG. 28, (a) shows sound pressure distribution on the observation planes X, Y, and Z viewed from above (a circle indicated by a dotted line in FIG. 29 shows a position of the speaker unit 6200).

It is apparent in FIG. 29 that, as the distance from the target observation plane to the speaker unit 6200 is increased (in other words, in an order of observation planes X, Y, and Z), variation of sound pressure on the observation plane is decreased and a wave field on the observation plane becomes more homogeneous, in both cases of a frequency of 100 Hz and a frequency of 300 Hz. In other words, as the observation plane 6200 is closer to the speaker unit 6200, the wave field is more unsteady.

Next, simulation is performed for sound pressure distribution in the situation where the target observation plane is very close to the speaker unit and the speaker unit has a diameter varying as 5 cm, 15 cm, and 30 cm.

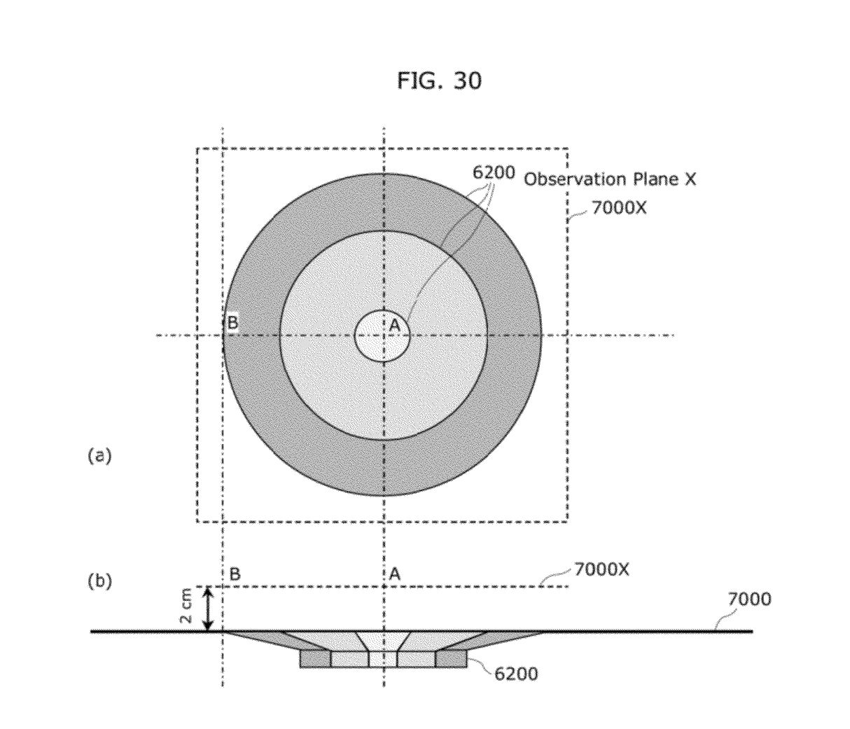

FIG. 30 shows a model for the simulation.

Here, as shown in the side view in (b) in FIG. 30, the observation plane X (observation plane 7000X) on which the sound pressure distribution is observed is set to be far from the speaker unit 6200 by 2 cm.

In FIG. 30, the diameter of the speaker is varied as 5 cm, 15 cm, and 30 cm. On the observation plane far from a diaphragm by 2 cm, sound pressure distribution characteristics at a position A corresponding to the center of the speaker are compared to sound pressure distribution characteristics of a position B.

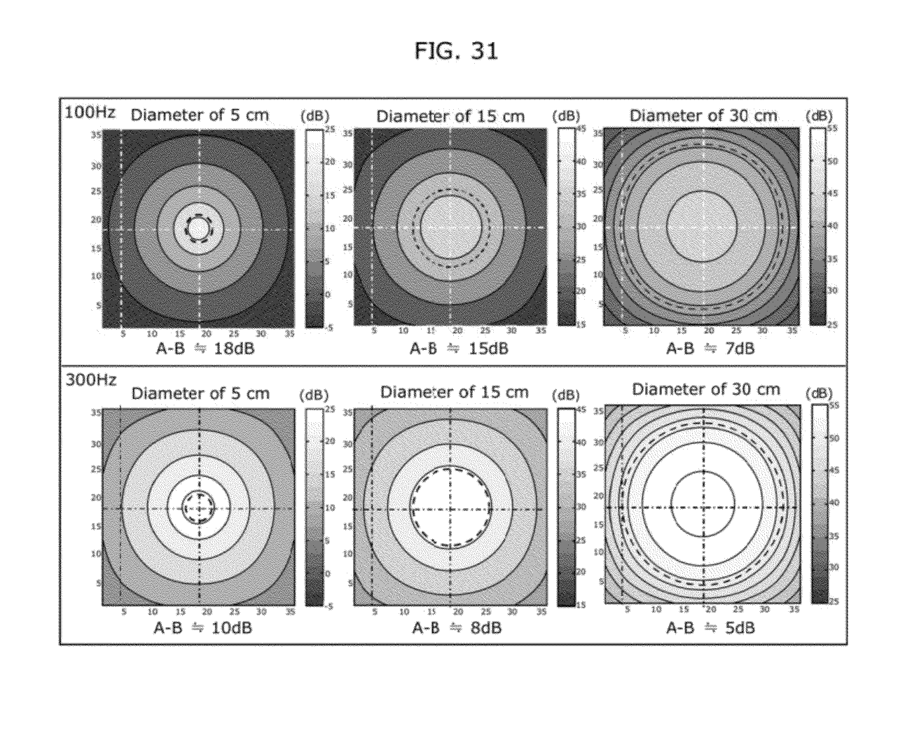

FIG. 31 shows sound pressure distribution on the observation plane X viewed from the above which is shown in (a) in FIG. 30 (a circle indicated by a dotted line in FIG. 31 shows a position of the speaker unit 6200).

It is apparent in FIG. 31 that, at any frequency of 100 Hz or 300 Hz, as the diameter of the speaker is increased, a region having a high sound pressure which includes the center of the speaker unit is increased. For example, when the position A is compared to the position B in FIG. 30, the larger diameter decreases more variation in the sound pressure distribution.

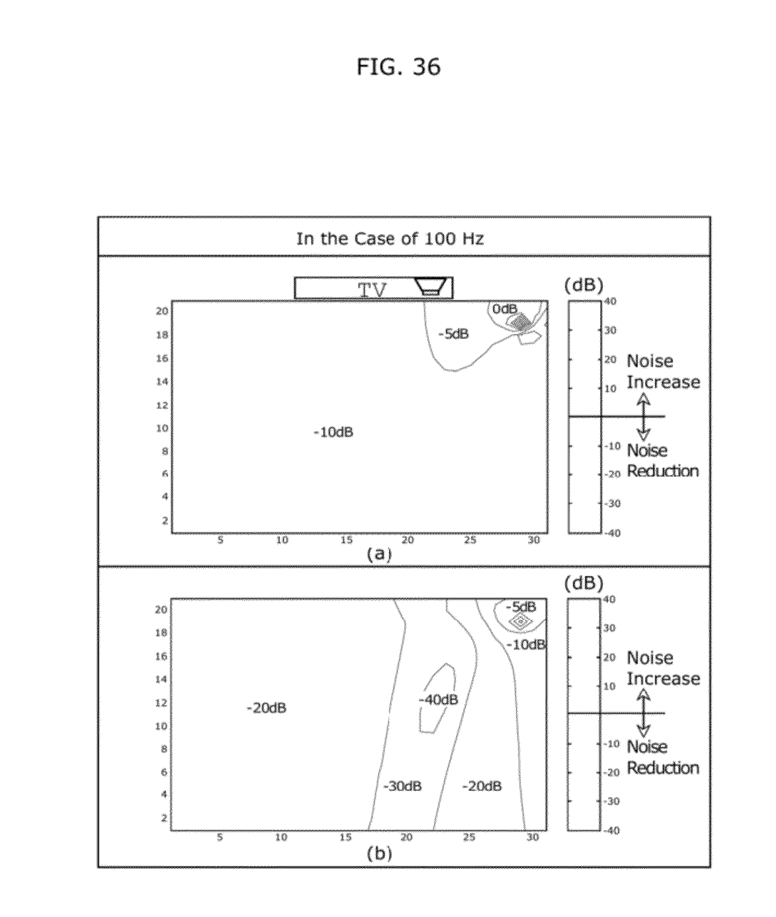

Here, FIGS. 36 to 40 and 41 to 43 show diagrams without shading shown in FIGS. 23 to 27 and 29 to 31, respectively. FIGS. 36 to 40 and 41 to 43 should be referred to as needed.

The above analysis results show that the wave field is not homogeneous when the target observation plane is very close to the speaker and that the larger diameter of the speaker is advantageous to produce more homogeneous wave field.

Although it is learned that the larger speaker diameter can produce homogeneous wave field, there are doubts about whether homogeneous noise control is possible even in the case where a plurality of speakers are arranged apart from one another by a long distance.

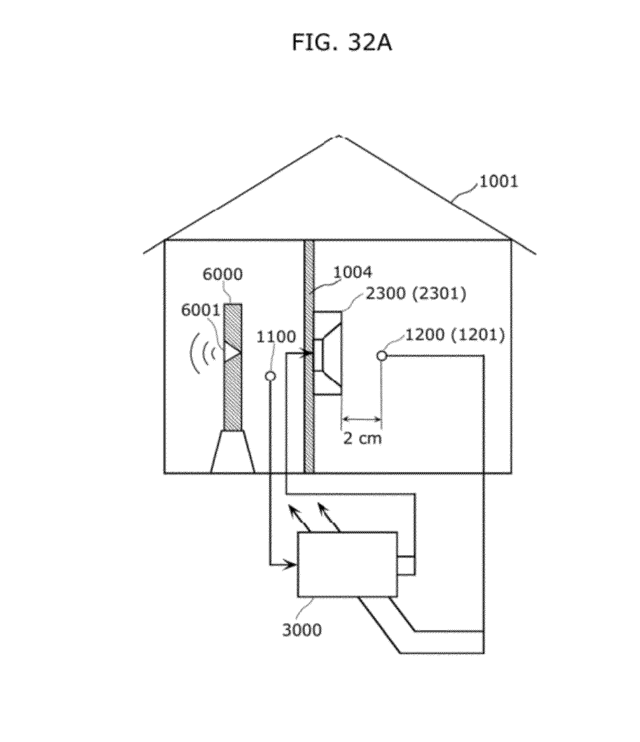

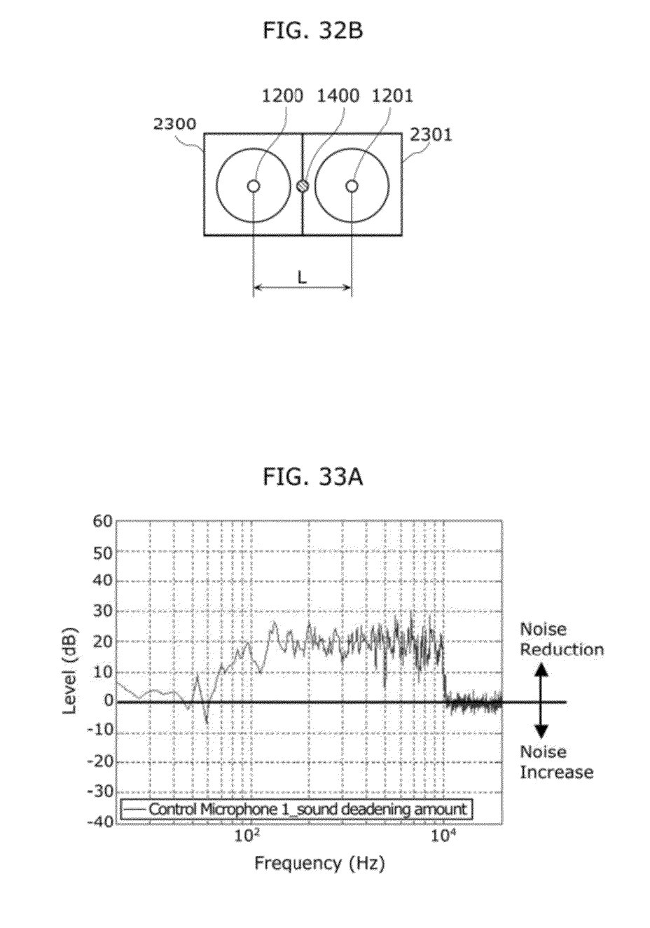

Each of FIGS. 32A and 32B is a diagram showing an experimental configuration for examining how a distance between speakers influences the noise reduction effects.

As shown in FIG. 32A, it is assumed that noise is emitted from a noise source (for example, the speaker 6001 embedded in the TV 6000), propagated via the wall 1004, and enters a target space in which the noise is to be controlled. Under the assumption, the two speakers 2300 and 2301 are equipped to the wall and the error microphones 1200 and 1201 are arranged so that each of the error microphones 1200 and 1201 is far from the center of the corresponding one of the speakers 2300 and 2301 by 2 cm. Here, the speakers 2300 and 2310 are assumed to be sealed speaker systems.

Then, the control filter 3000 reduces the noise detected by the error microphones 1200 and 1201. Here, the internal structure of the control filter 3000 is the same as the above-described structure shown in FIG. 17.

It should be noted in the above configuration that the noise microphone 1100 detects noise signal, but it is also possible that electric signal provided to the speaker 6001 is considered as noise signal because the noise source is the speaker 6001.

In the above-described sound-field control, a distance L between the speaker 2300 and the speaker 2301 shown in FIG. 32B is varied to compare resulting noise reduction effects. In addition to the error microphones 1200 and 1201, a microphone (evaluation microphone) 1400 as an evaluation point is provided between the speakers.

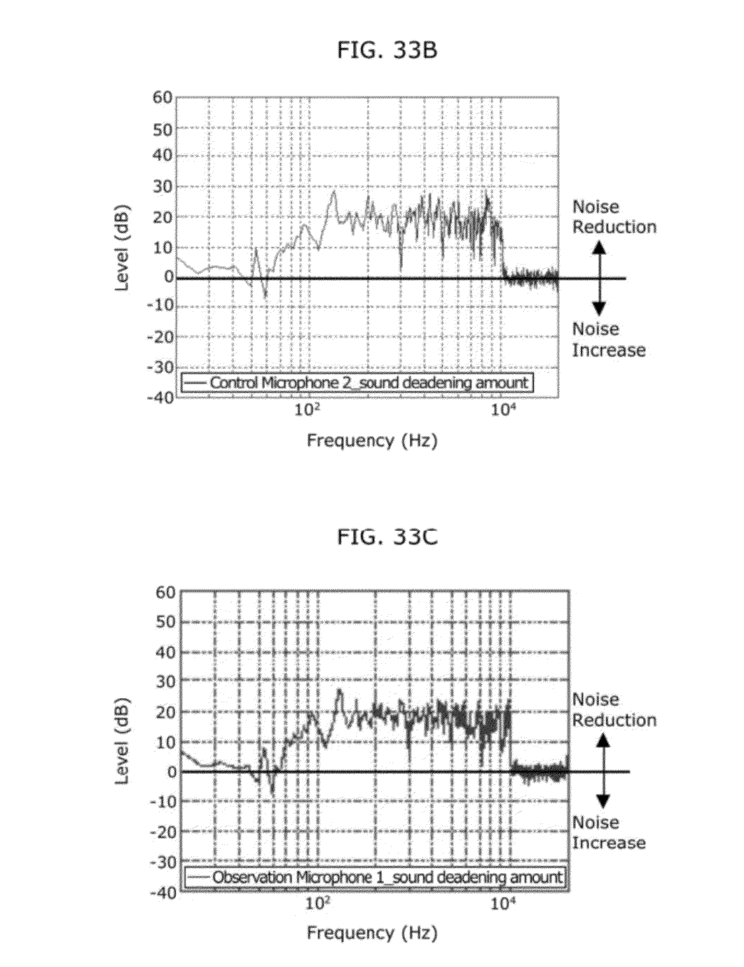

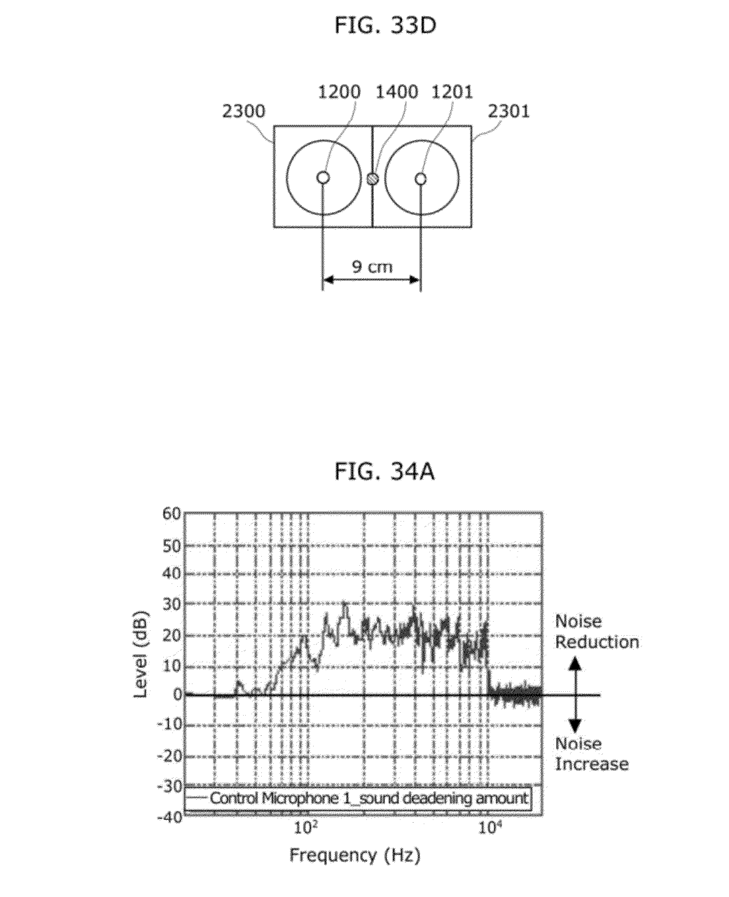

Each of FIGS. 33A and 33D shows noise reduction effects in the case where the distance L between the speakers is 9 cm.

Here, the diameter of each of the speakers 2300 and 2301 is 8 cm. Therefore, cabinets of the two speakers are adjacent to each other (in other words, a horizontal size of each of the speakers 2300 and 2301 is 9 cm). FIG. 33A shows noise reduction effects detected by the error microphone 1200. FIG. 33B shows noise reduction effects detected by the error microphone 1201. FIG. 33C shows noise reduction effects detected by the evaluation microphone 1400.

Here, the noise reduction effects are a difference between detected sound signal before the noise reduction control and detected sound signal after the noise reduction control. Therefore, a numeral value in each graph represents an amount of the noise reduction. A plus numeral value (for example, 20 dB) means that the noise is reduced.

In any cases in a range from a frequency of 100 Hz to a frequency 1000 Hz, the noise is reduced by approximately 20 dB. Therefore, the distance between the speakers can produce the same noise reduction effects and achieve the homogeneous sound-field control when the control filter 3000 controls the control points of the error microphones 1200 to 1201.

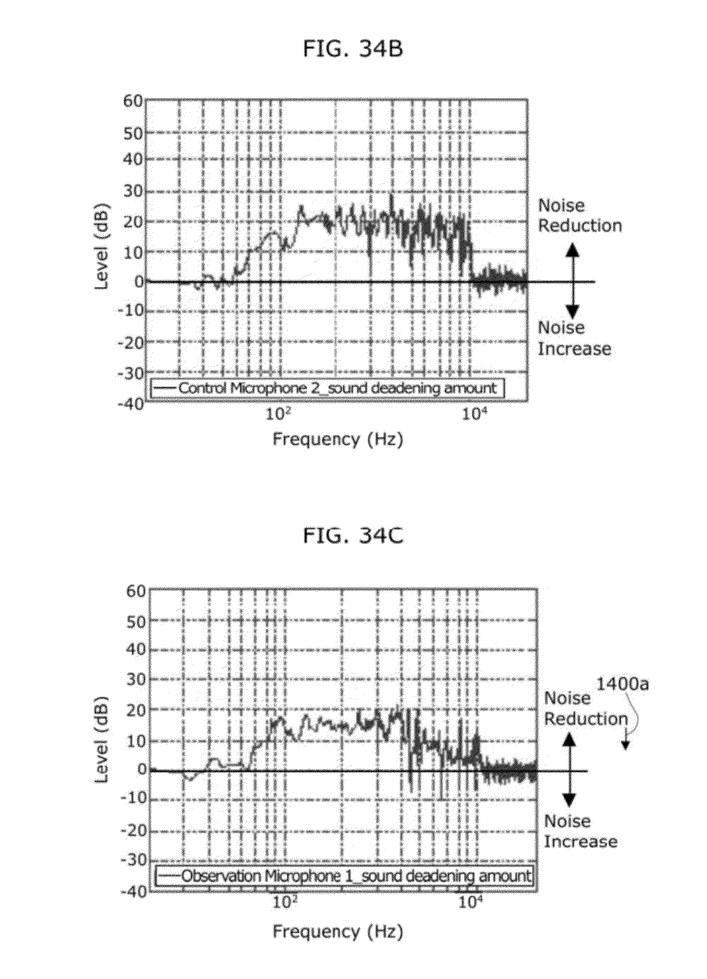

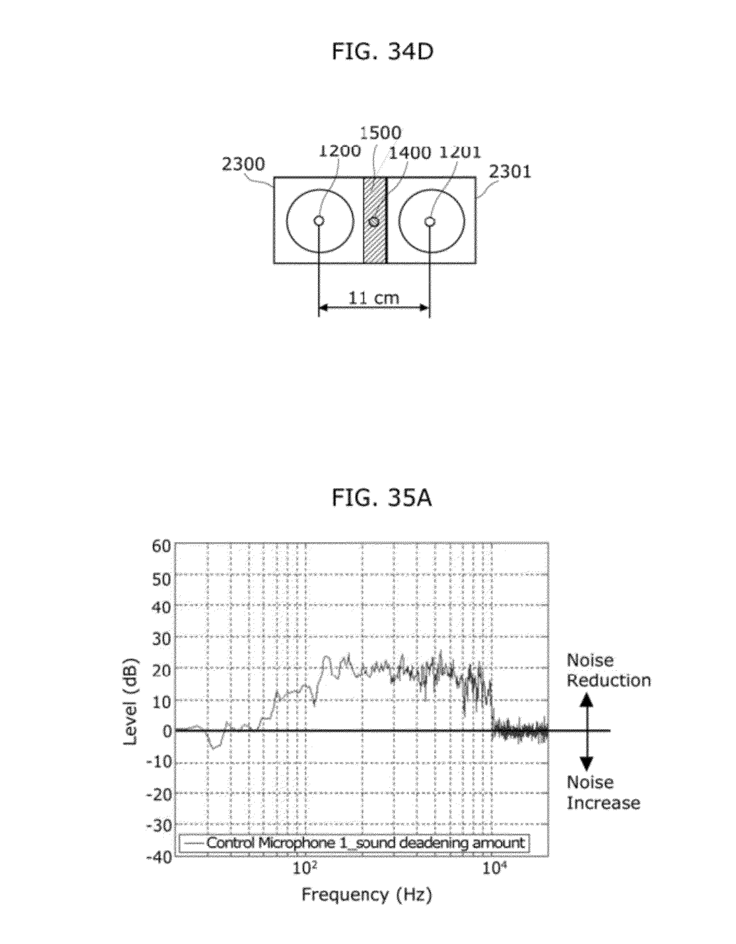

Each of FIGS. 34A and 34B shows noise reduction effects in the case where the distance L between the speakers is 11 cm.

In this example, as shown in FIG. 34D, there is a gap between the cabinets of the two speakers, and a panel 1500 is provided to fill the gap. Therefore, the configuration is similar to the configuration in which the speakers 2300 and 2301 are embedded in a wall.

The above configuration is provided not to allow the noise to propagate directly from the gap, and to produce baffle effects for the speakers 2300 and 2301. Noise reduction effects in FIG. 34A (namely, the effects detected by the error microphone 1200) are compared to the noise reduction effects in FIG. 34B (namely, the effects detected by the error microphone 1201). Likewise the case shown in FIGS. 33A and 33B, the noise is reduced by approximately 20 dB in a range from a frequency of 100 Hz to a frequency of 1000 Hz. However, the noise reduction effects in FIG. 34C (namely, the effects detected by the evaluation microphone 1400) are decreased by approximately 5 bB as a whole (see an arrow 1400a).

It is considered that the homogenous sound-field control is getting lost at the distance L of 11 cm or more.

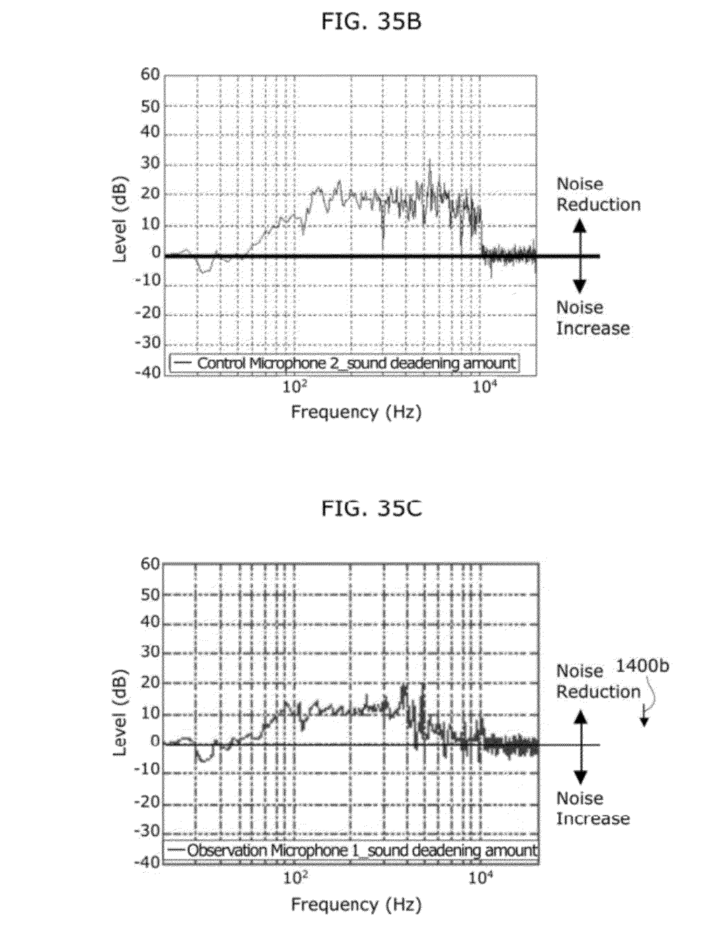

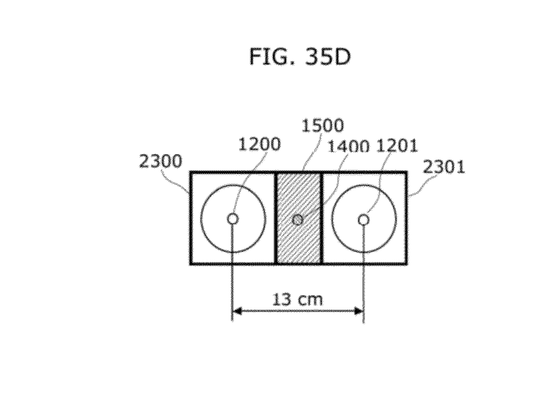

Each of FIGS. 35A and 35B shows noise reduction effects in the case where the distance L between the speakers is 13 cm.

Noise reduction effects in FIG. 35A (namely, the effects detected by the error microphone 1200) are compared to the noise reduction effects in FIG. 35B (namely, the effects detected by the error microphone 1201). Likewise the case shown in FIGS. 33A and 33B, the noise is reduced by approximately 20 dB in a range from a frequency of 100 Hz to a frequency of 1000 Hz. However, the noise reduction effects in FIG. 35C (namely, the effects detected by the evaluation microphone 1400) are decreased by approximately 5 bB as a whole (see an arrow 1400b). It is therefore considered that the homogeneous sound-field control is impossible at the distance L of 13 cm.

The above analysis results show that a shorter distance between speakers results in more homogeneous sound-field control. However, a short distance between speakers increases the number of employed speakers. As a result, an arithmetic operation amount is increased.

The above-described analysis results are summarized into the following (1) to (3).

From the analysis results shown in FIGS. 21 to 27, the following is learned.
(1) In order to reduce noise in a range as wide as possible in a to-be-controlled space, it is necessary to control noise homogeneously on an entire wall (a region as wide as possible) from which noise is propagated.

From the analysis results shown in FIGS. 28 to 31, the following is learned.
(2) If an observation plane is very close to a speaker, a wave field on the observation plane is not homogeneous. In order to produce a homogeneous wave field, it is necessary to increase a diameter of the speaker.

From the analysis results shown in FIGS. 32A to 35D, the following is learned.
(3) In order to achieve homogeneous sound-field control, it is advantageous to arrange speakers to be adjacent to each other.

However, if (1) and (3) are satisfied, there is a problem of increase of an arithmetic operation amount. For example, if a cabinet of a speaker has a size of 10 cm³, one hundred of speakers are to necessary to homogeneously control the sound field on the wall of 1 square meter.

Here, a speaker having a large diameter is used to satisfy (2), provision of a small number of speakers results in decrease of the arithmetic operation amount. However, a speaker having a large diameter is generally thick. Therefore, such a speaker cannot be embedded in a wall, or the wall needs a rigidity enough to support the weight of the speaker (in other words, a common wall cannot support the speaker weight).

The conventional arts therefore have difficulty in satisfying all of (1), (2), and (3) while suppressing an arithmetic operation amount. Without some sort of innovation, it is not possible to achieve desired noise control and produce effects of sound field control.

In order to address the above problems, an object of the present invention is to provide a speaker that is embedded in a wall together with an error microphone to reduce noise or improve audio effects in a wide area without obstructing people moving in the area such as a room and that is provided at low cost.

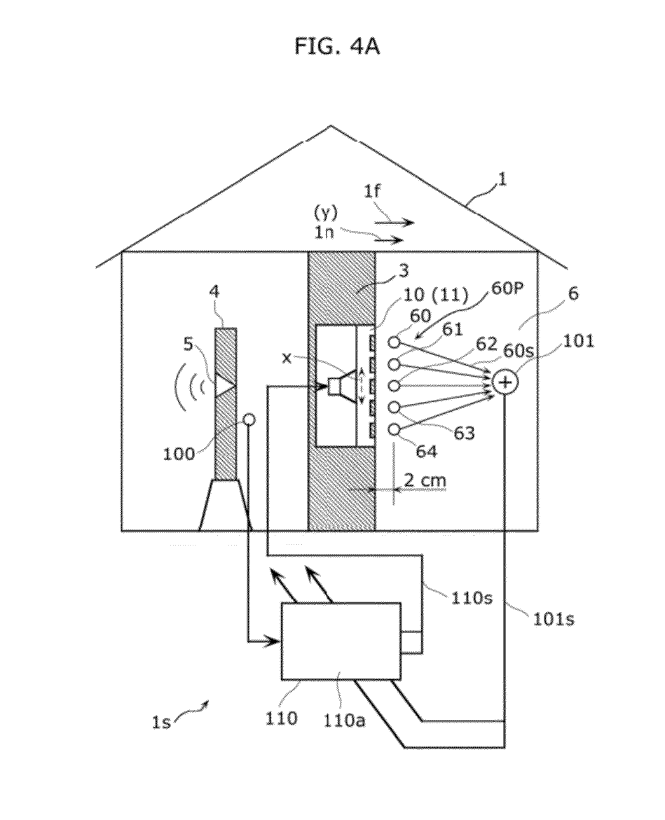

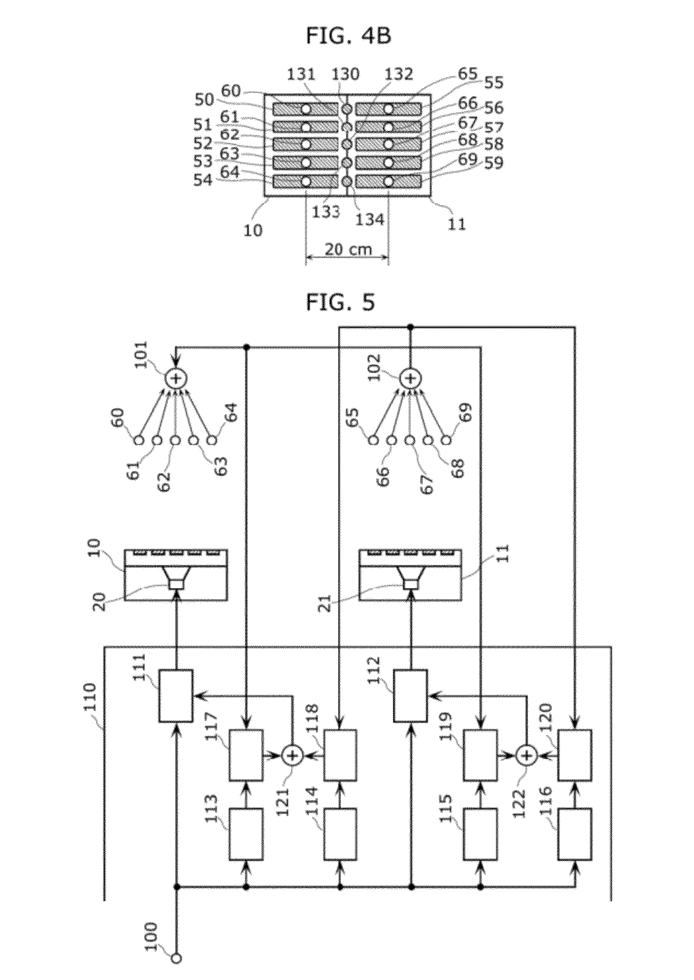

Another object of the present invention is to provide a speaker (for example, a speaker 10 in FIG. 4A) embedded in a wall (for example, a wall 3 in FIG. 4A) that is far from an error microphone (for example, an error microphone 60 in FIG. 4A or the like) by a distance (for example, a distance 1f, a distance 1n, or the like). The speaker and the error microphone are included in a sound control system. In other words, another object of the present invention is to provide a speaker for which the distance is decreased (see the distance 1n) so that a configuration of the sound control system is unlikely to obstruct a user moving around in a target space.

### Means To Solve the Problems

In accordance with an aspect of the present invention for achieving the object, there is provided a speaker including: a driver; a passive radiator in front of the driver; and a cabinet storing the driver and covering a rear space of the driver to seal a space between the driver and the passive radiator, wherein an effective piston area of the passive radiator is larger than an effective piston area of the driver.

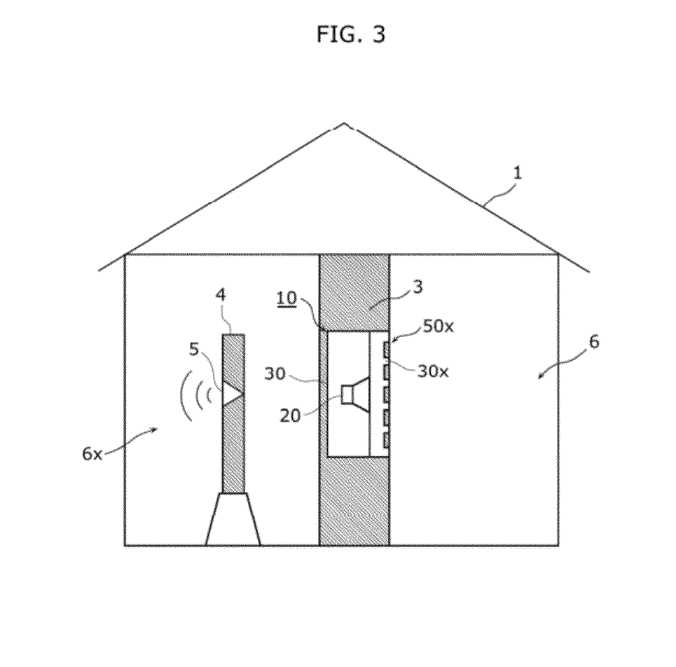

More specifically, for example, a space (such as a space 6 in FIG. 3) to which the speaker in accordance with the aspect of the present invention emits sound is a space where a user listens to the sound. Therefore, the space is a three-dimensional space, not a two-dimensional space such as a space inside the duct (pipe line) 1000 in the conventional art as described previously. For example, this speaker and an error microphone (such as an error microphone 60 in FIG. 4A) are included in a sound control system. The speaker is provided with the above-described passive radiator. The error microphone is positioned far from a wall (such as the wall 3 in FIG. 4A) in which the speaker is embedded, by an adequately short distance (such as a distance 1n). As a result, the configuration of the sound control system is appropriate not to obstruct, for example, the user moving in the space (such as the space 6) to which the sound is emitted.

It should be noted that the passive radiator is provided in front of the driver. This means that the passive radiator is provided in a direction of emitting the sound reproduced by the driver. For example, since a space between the passive radiator and the driver is sealed, the passive radiator is oscillated according to the sound reproduced by the driver.

In accordance with an aspect of the present invention, there is provided a sound control system including the above-described speaker, wherein the sound control system detects a signal produced by a sound source, processes the signal by a control filter, and causes the speaker to emit, as a controlled sound, the signal processed by the control filter, so that the controlled sound offers a predetermined effect at a control point.

With the above structure, for example, since the above-described space between the passive radiator and the driver is sealed, the provided passive radiator performs oscillation (for example, piston oscillation) according to oscillation of the sound reproduced by the driver. As a result, sound is emitted by an effective piston area of the passive radiator.

It is preferable that the control point is positioned close to the speaker, the sound control system further includes an effect sensor arranged at the control point to detect an effect of control of the sound control system, and the control filter adjusts control characteristics of the control filter based on an detected signal of the effect sensor. With the above structure, an effective region in a to-be-controlled space can be increased. In addition, it is possible to adjust characteristics of the control filter based on a change of characteristic of the to-be-controlled space or a change of characteristic change of a sound source.

It is preferable that the sound control system includes a plurality of effect sensors including the effect sensor. With the above structure, while an arithmetic operation load is reduced, it is possible to further average unsteadiness of a wave field of the reproduced sound detected at a position very close to the speaker. As a result, the sound control effects (such as noise reduction effects) can be increased.

It is preferable the sound control system wherein the control characteristic of the control filter are adjusted based on a signal generated by summing detected signals of the effect sensors. With the above structure, it is possible to offer the same sound control effects while an availability is increased and a const is reduced.

It is preferable that the sound control system includes a plurality of speakers including the speaker, wherein the speakers include two speakers adjacent to each other. With the above structure, deterioration of the sound control effects among the speakers is suppressed. As a result, it is possible to offer homogeneous sound control effects in a wide region.

It is preferable that the speakers are equipped in a wall. With the above structure, it is possible to offer good sound control effects in the entire to-be-controlled space.

It is preferable that aid driver and the passive radiator in each of the speakers are embedded in the wall. With the above structure, it is possible to reduce a cost and ensure sound control effects.

### Effects of the Invention

The speaker according to the present invention is included in a sound control system. As a result, it is possible to provide a low-cost sound control system including a speaker and an error microphone embedded in a wall, so that the speaker and the error microphone do not obstruct, for example, a person moving in a room having the wall, and noise is reduced and audio effects are improved in a wide area.

The provision of the speaker according to the present invention allows the sound control system to have an appropriate configuration.

The configuration of the sound control system including the speaker is unlikely to obstruct a movement of the user and the like.

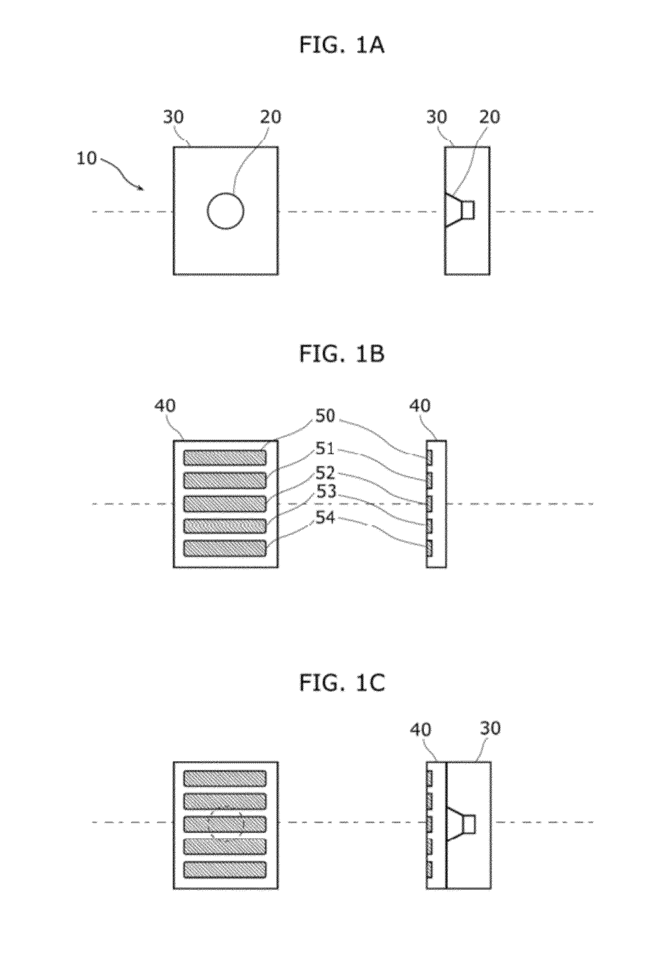

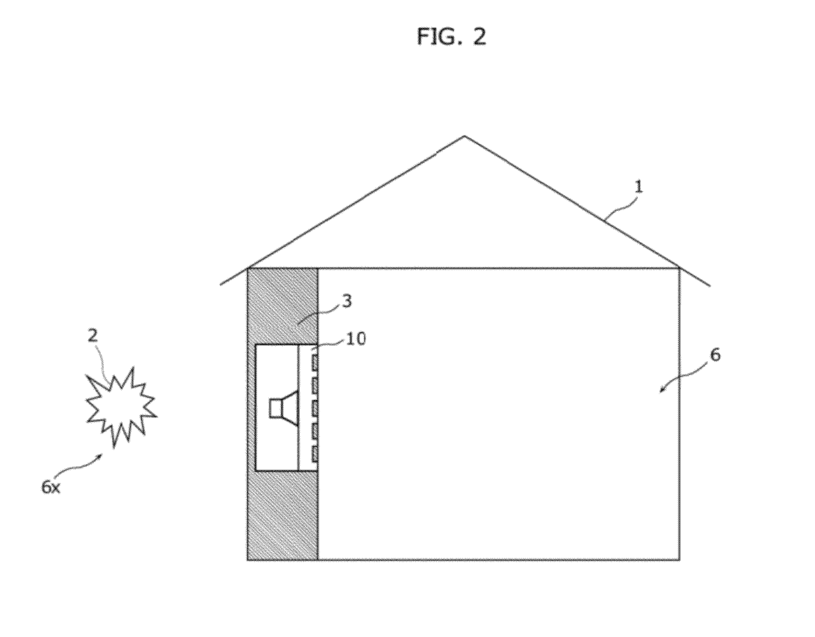

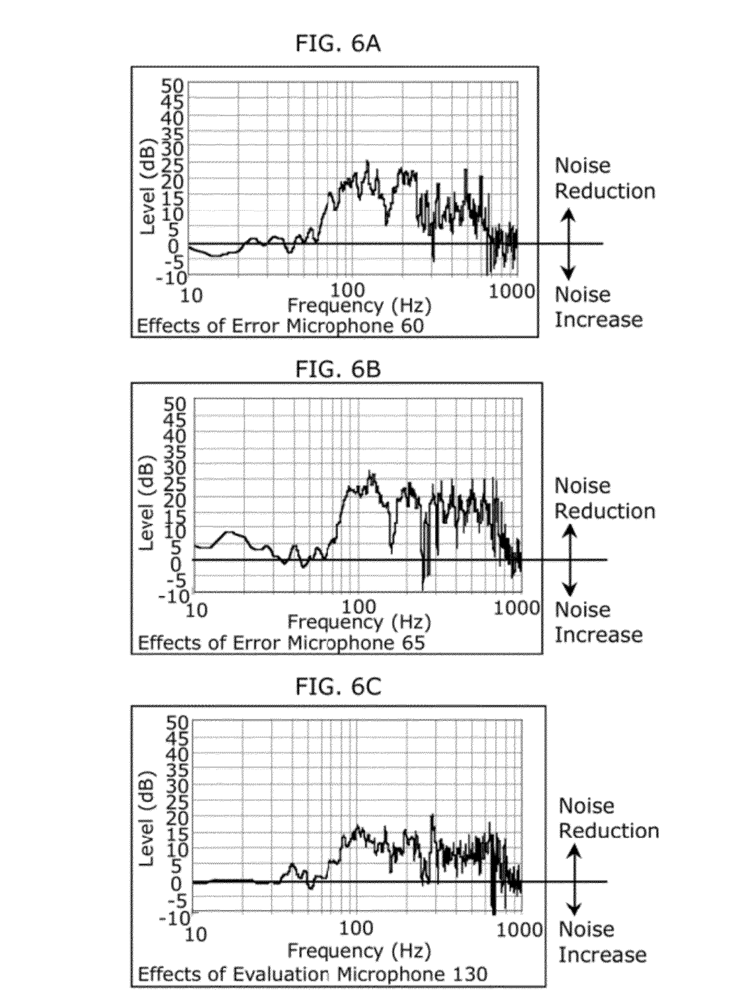

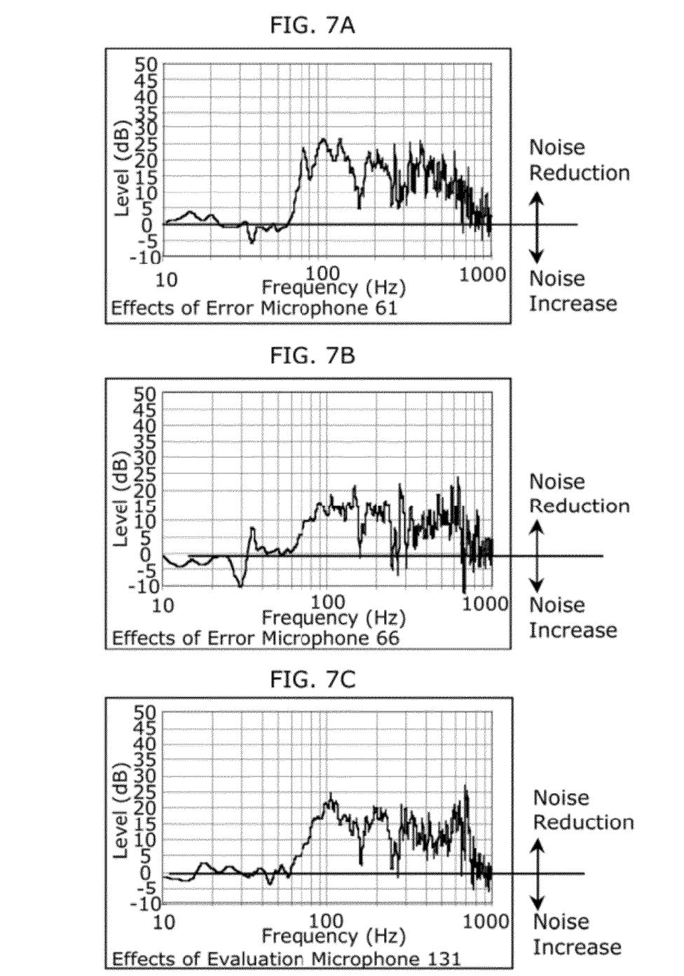

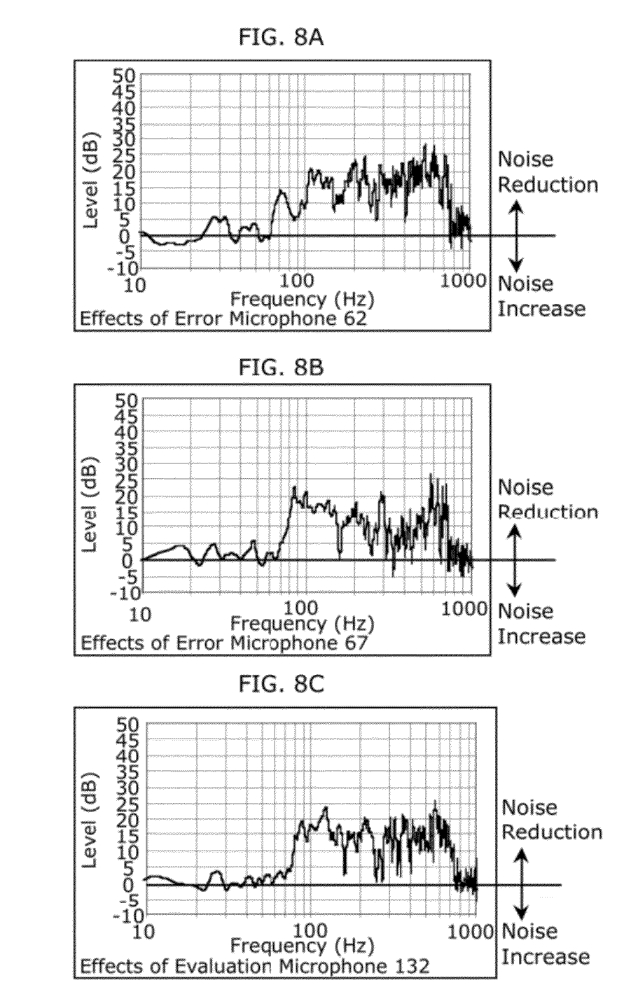

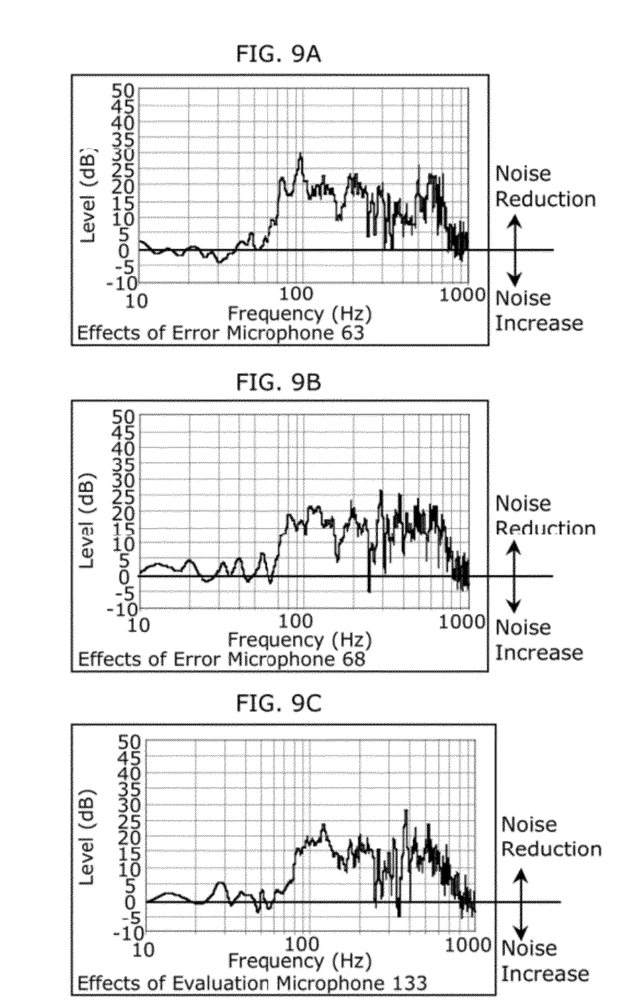

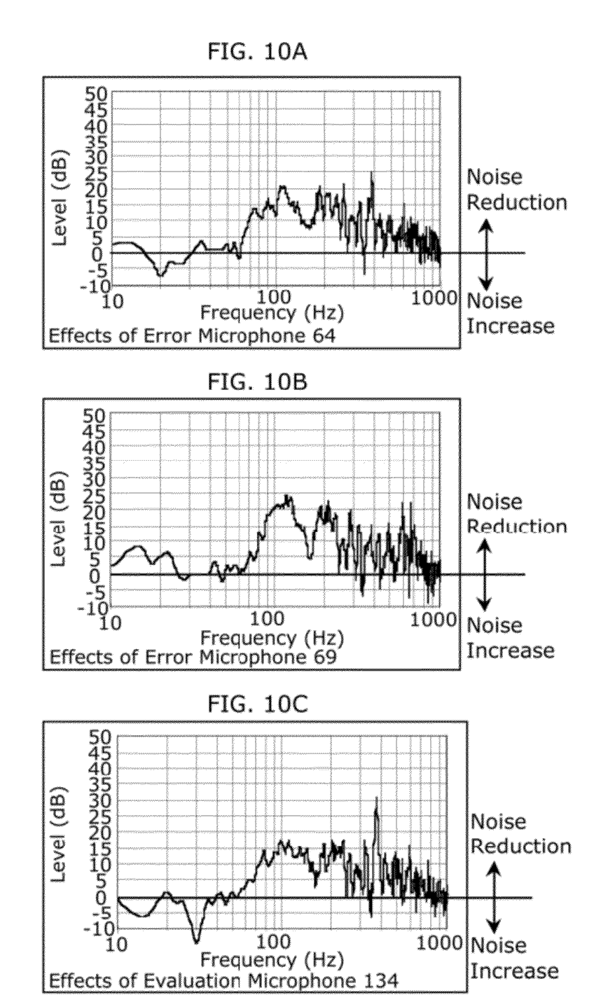

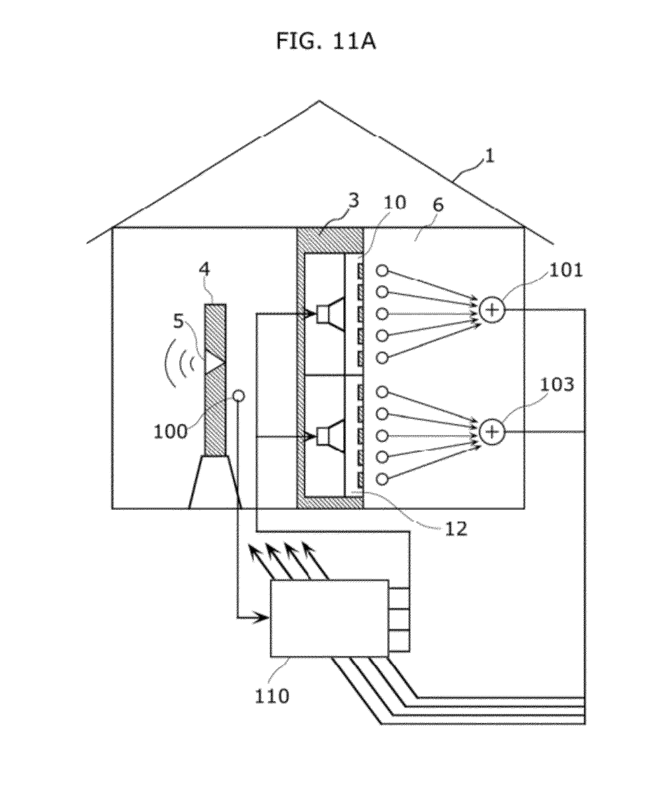

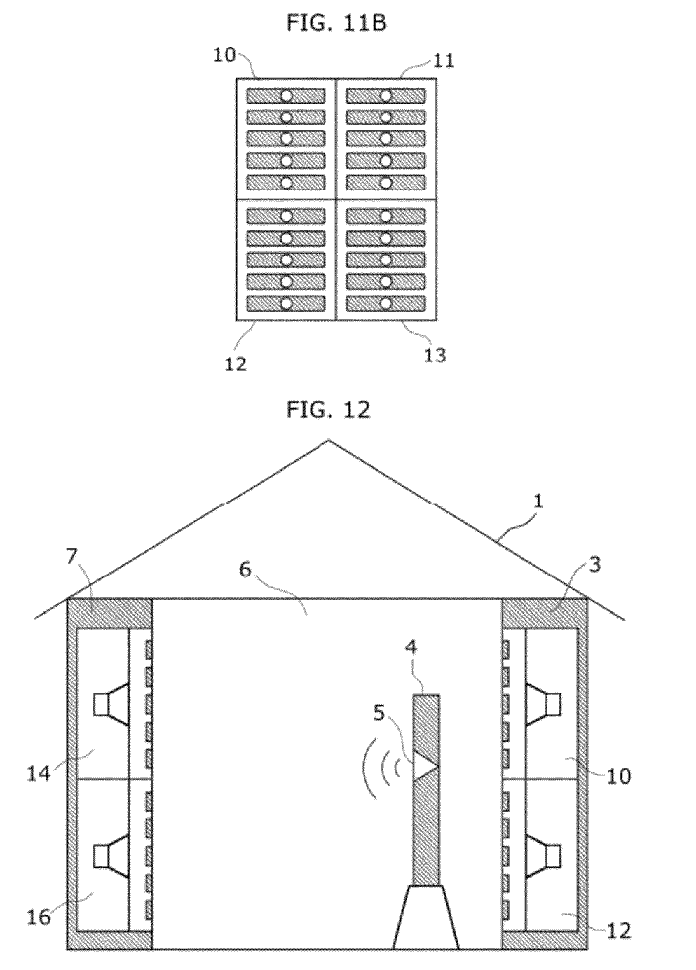

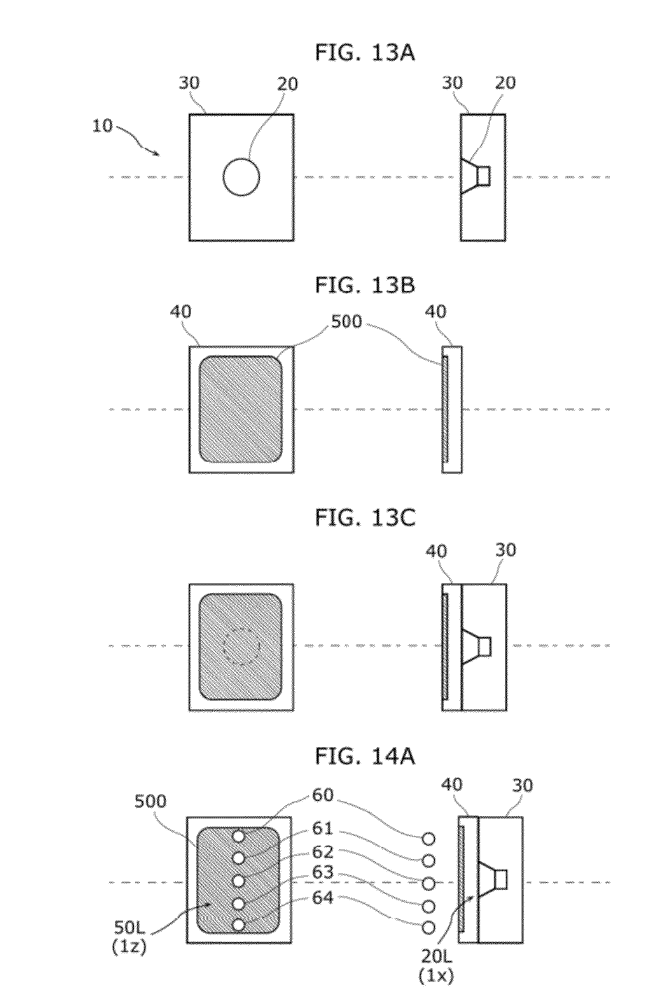

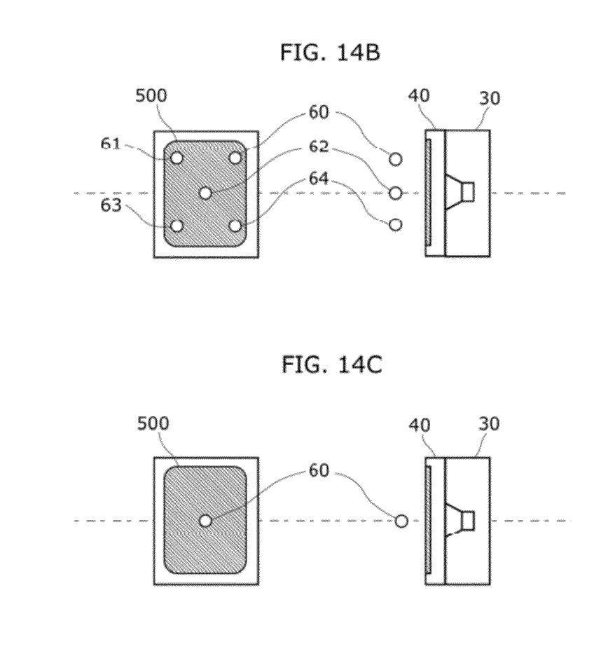

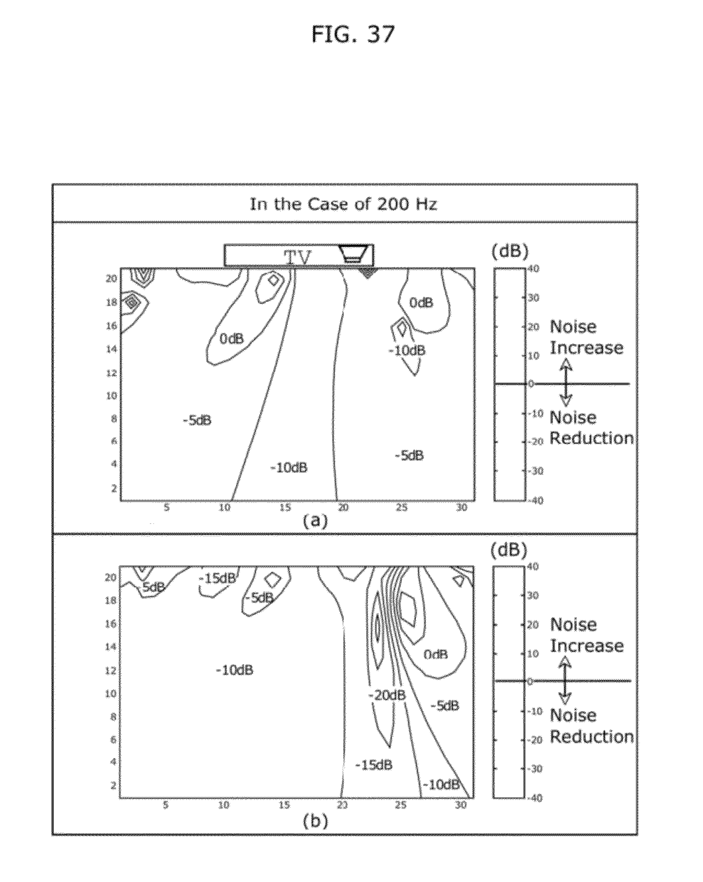

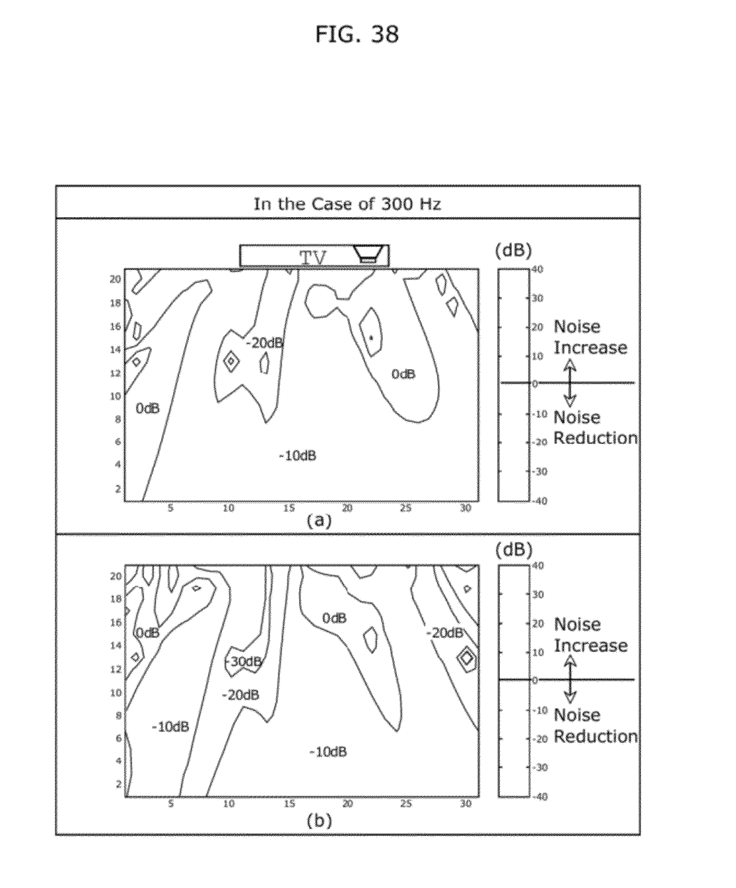

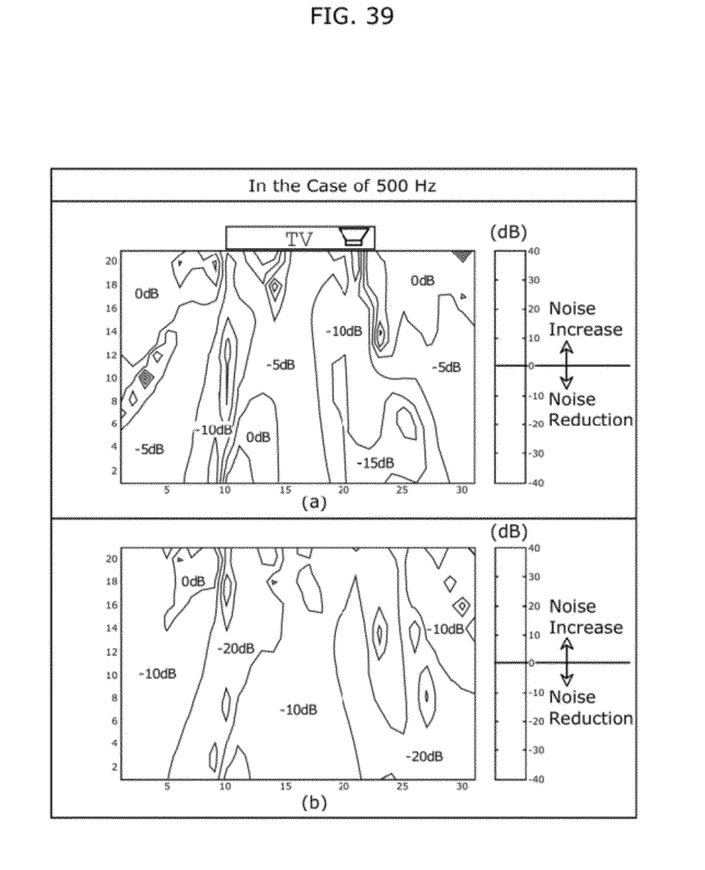

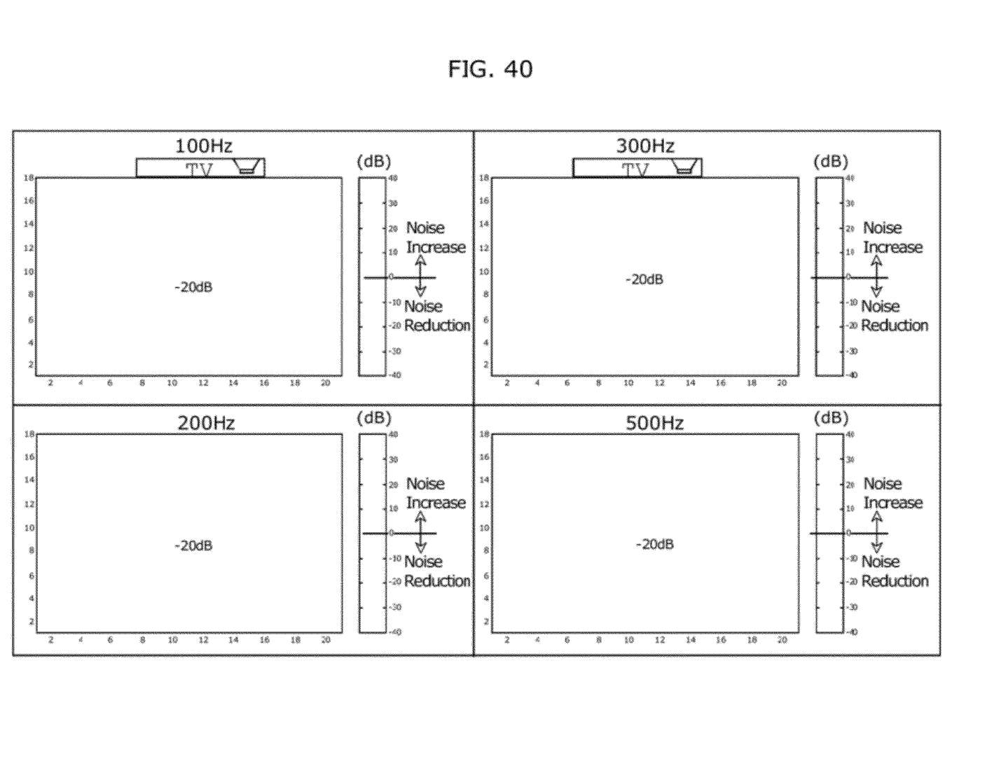

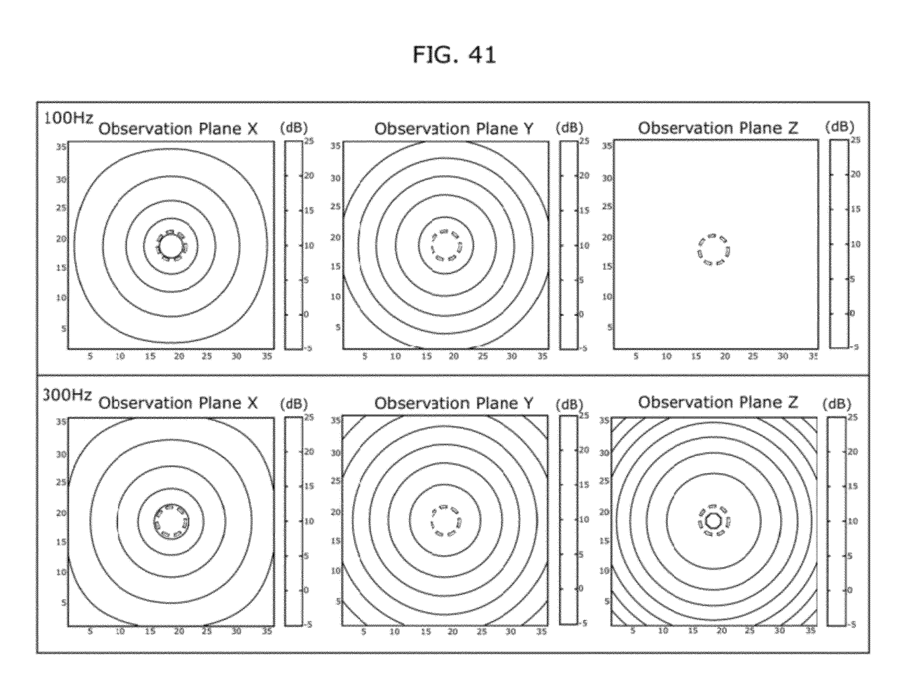

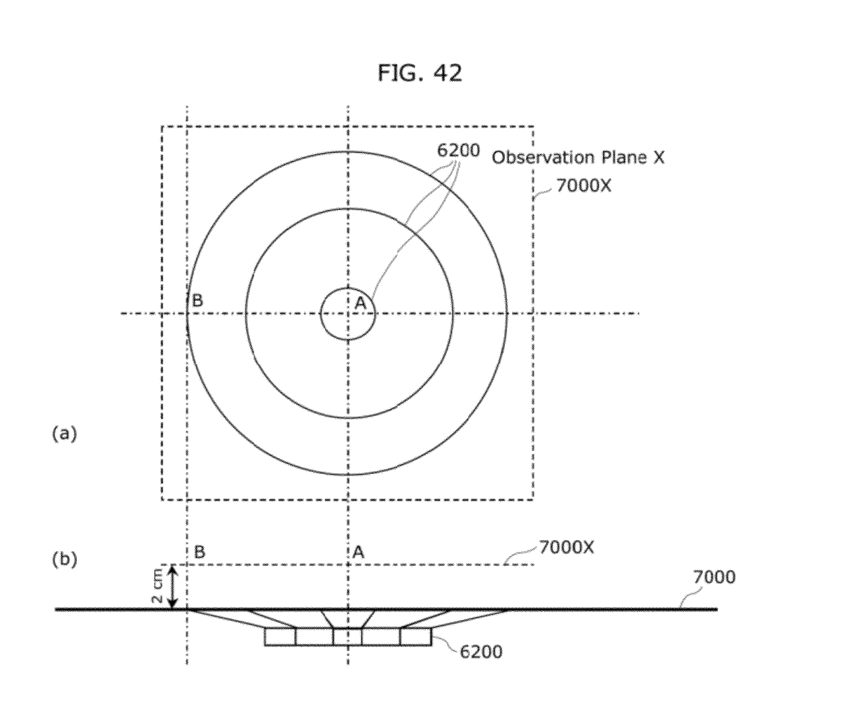

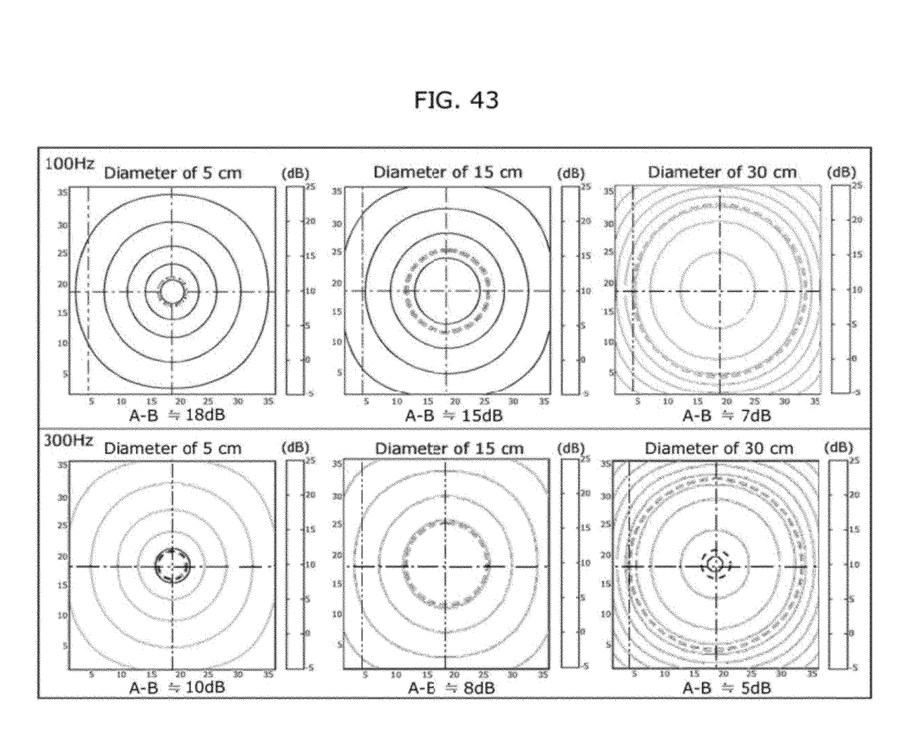

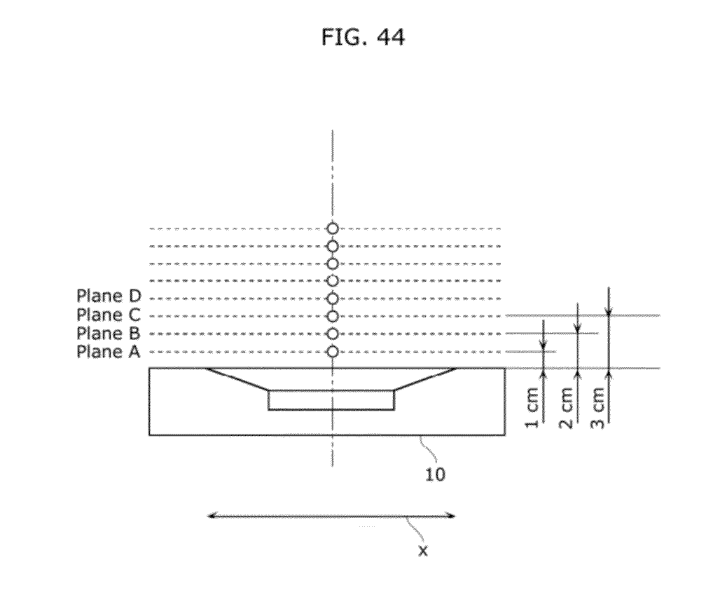

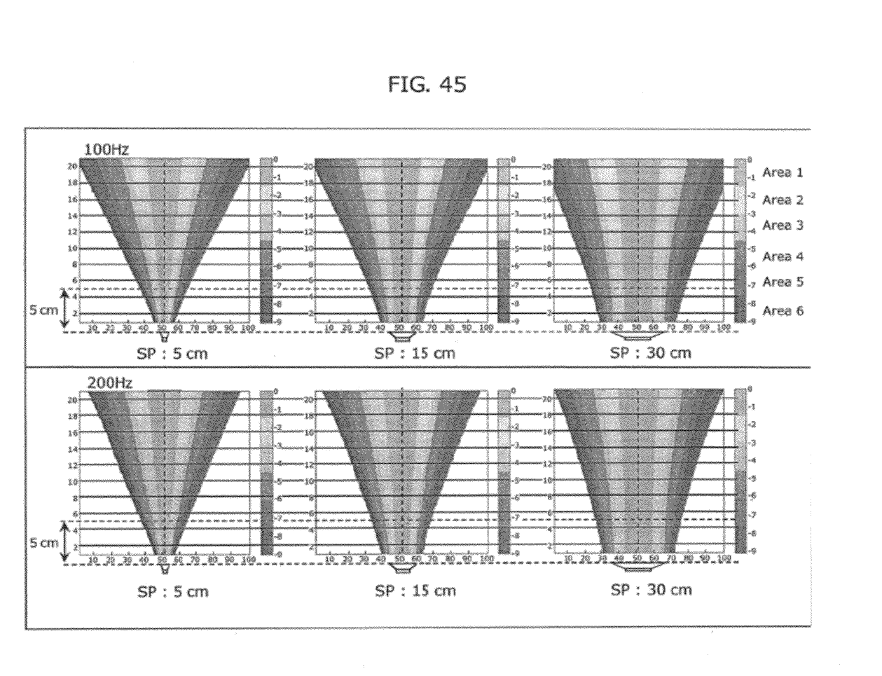

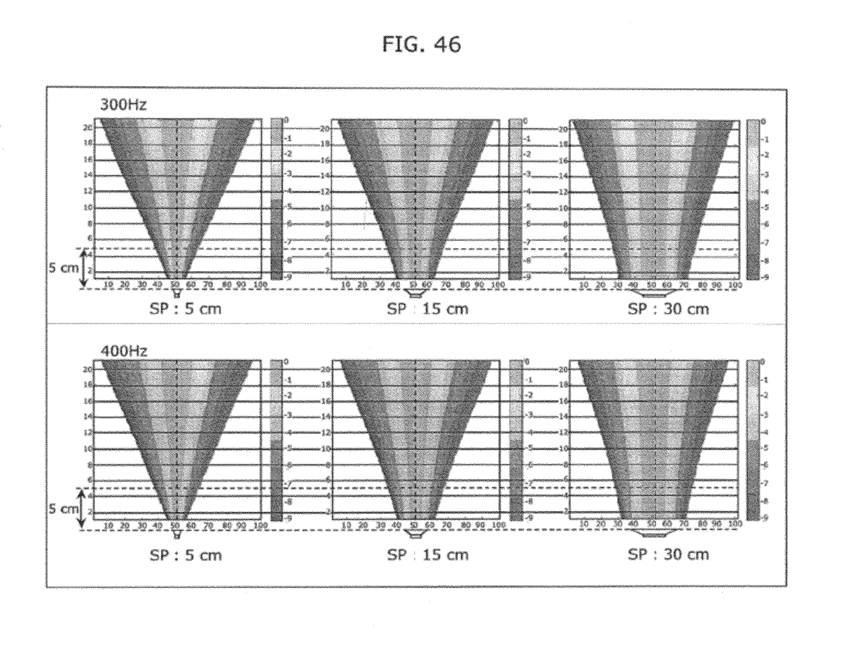

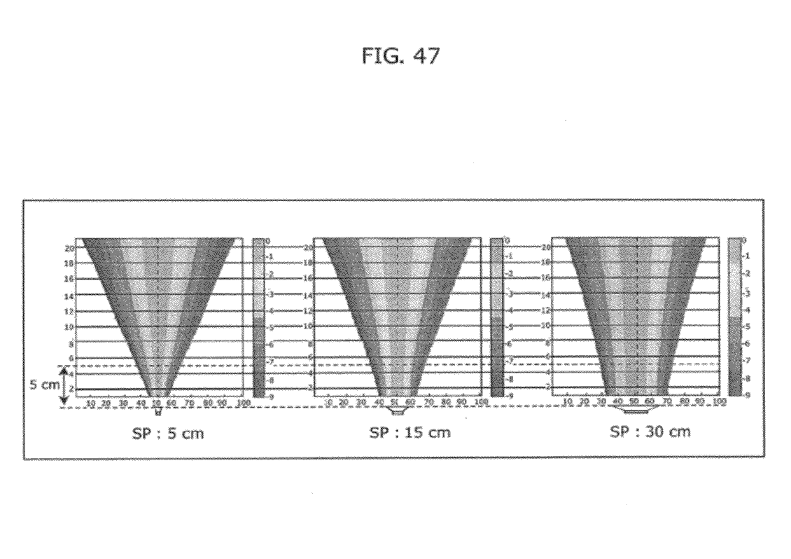

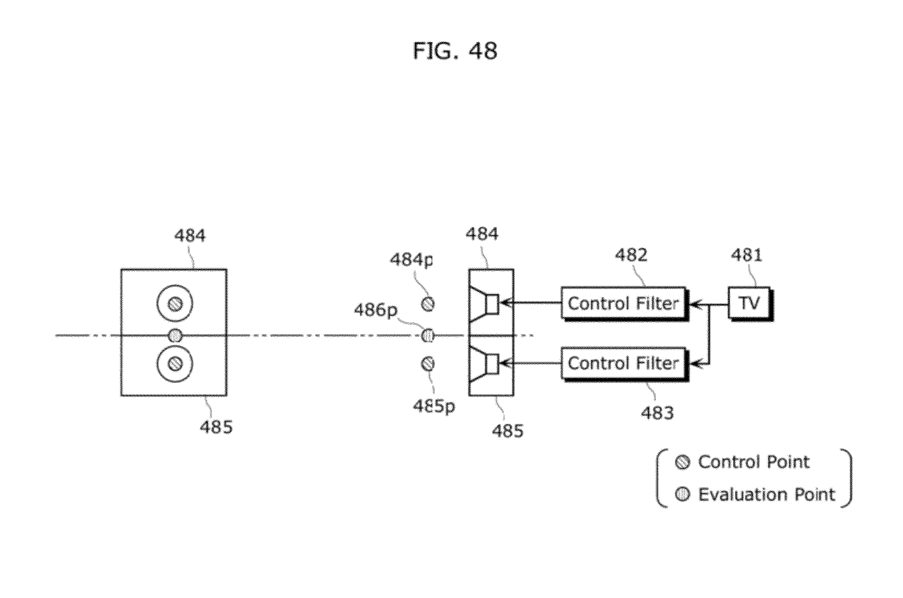

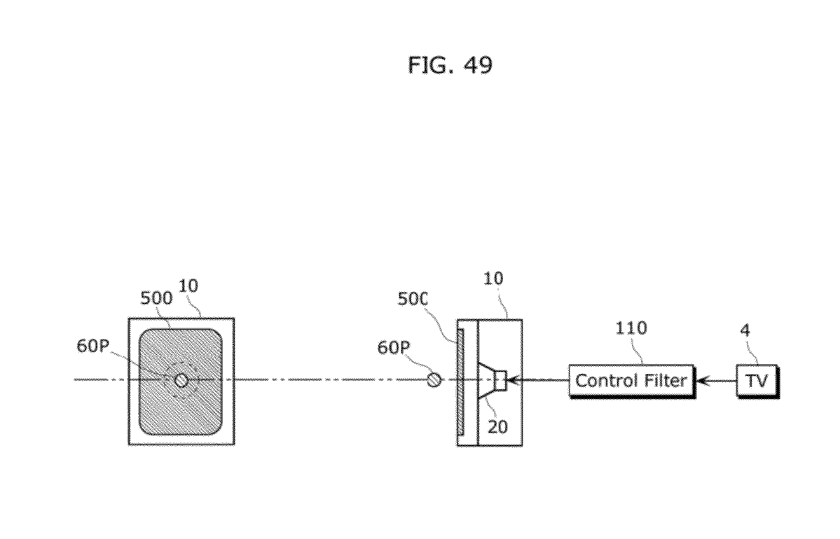

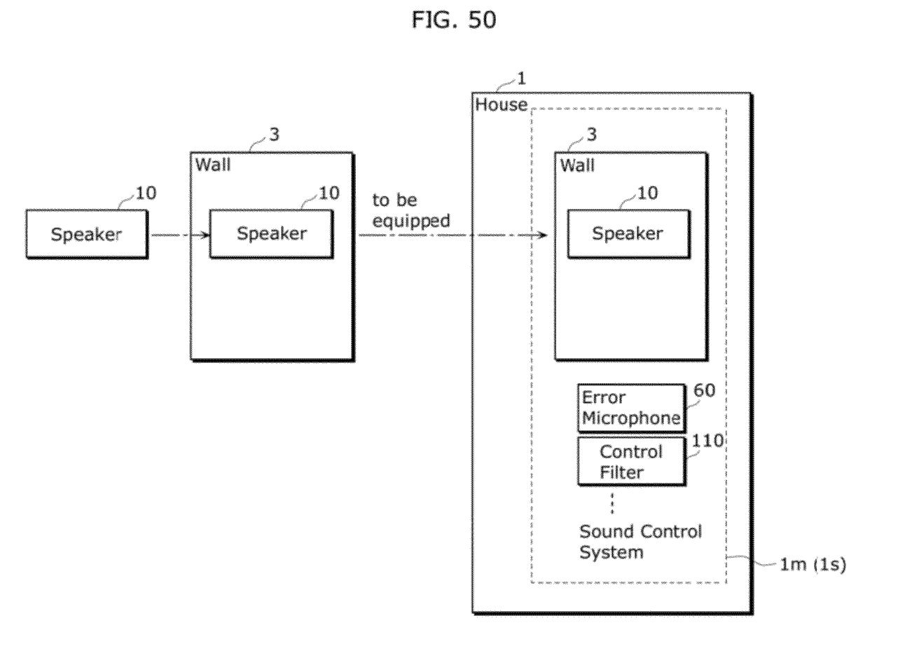

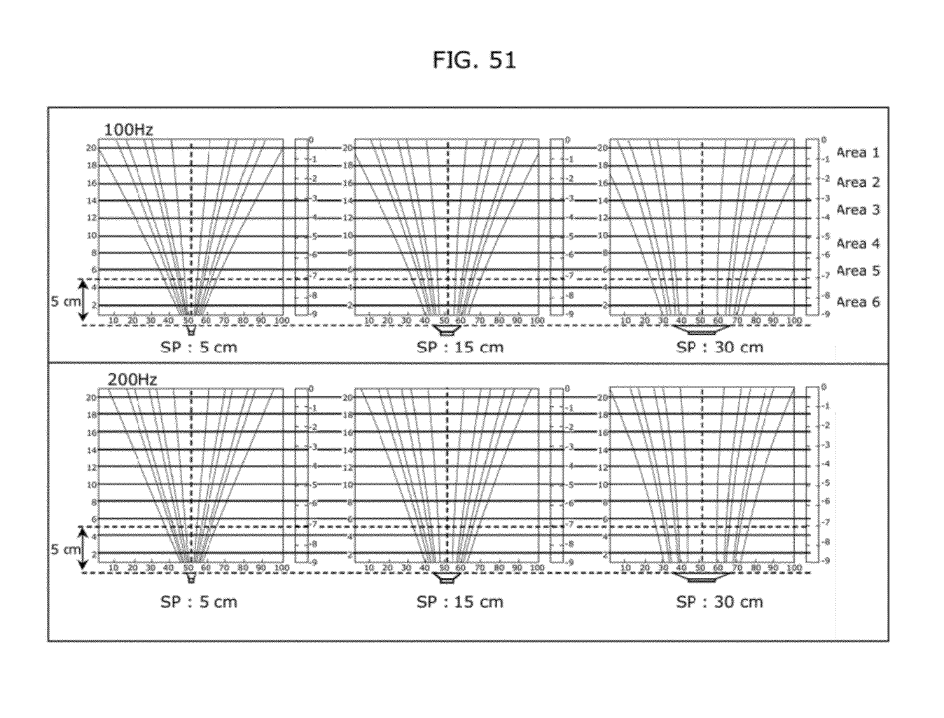

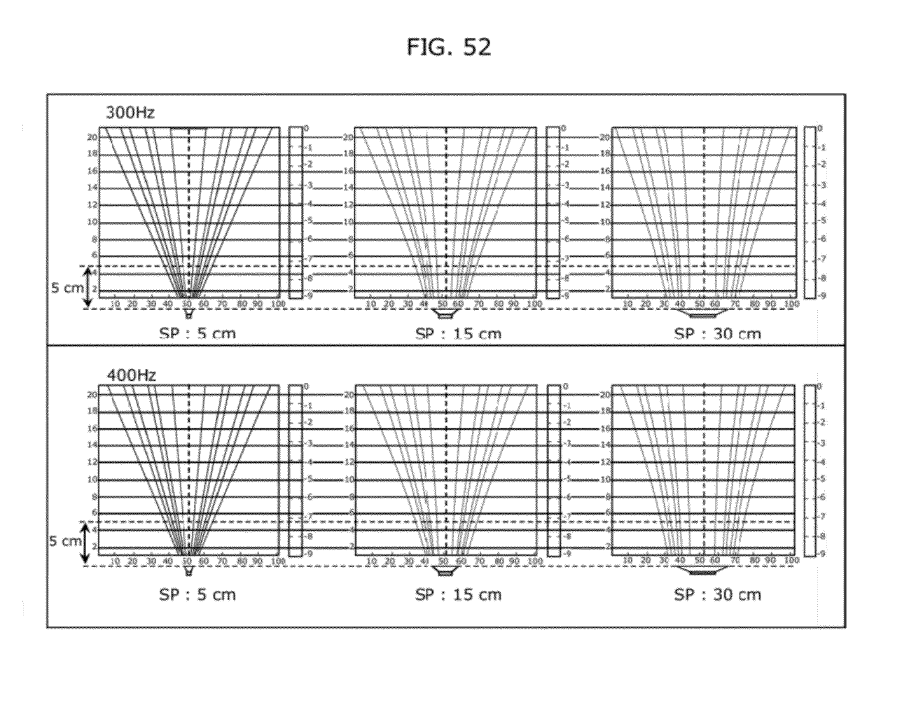

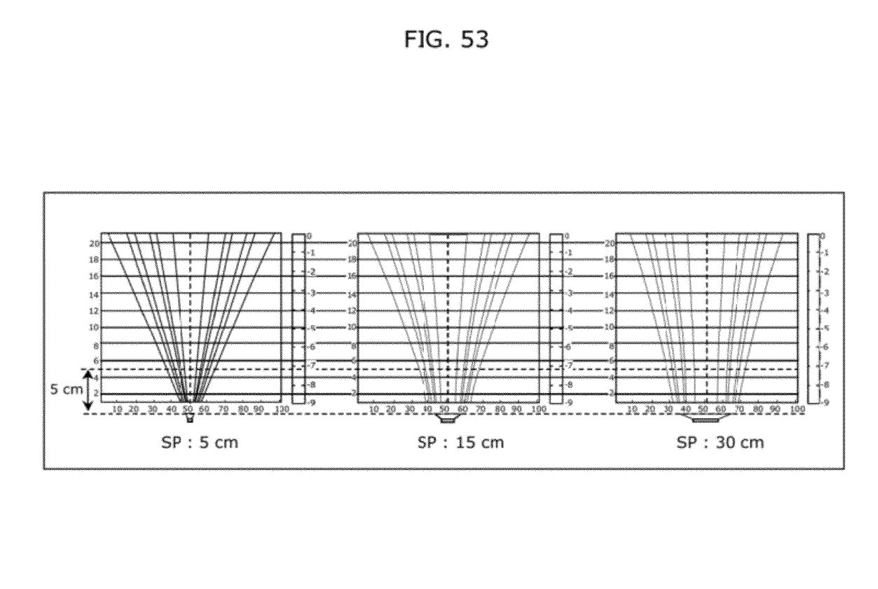

### BRIEF DESCRIPTION OF DRAWINGS

[FIG. 1A] FIG. 1A is a diagram showing a structure of a speaker in a sound control system according to a first embodiment of the present invention.

[FIG. 1B] FIG. 1B is a diagram showing another structure of the speaker in the sound control system according to the first embodiment of the present invention.

[FIG. 1C] FIG. 1C is a diagram showing still another structure of the speaker in the sound control system according to the first embodiment of the present invention.

[FIG. 2] FIG. 2 is a diagram showing a situation where a noise source is outside a house.

[FIG. 3] FIG. 3 is a diagram showing a situation where a noise source is inside a house.

[FIG. 4A] FIG. 4A is a diagram showing a control configuration of the sound control system in the situation where a noise source is inside a house.

[FIG. 4B] FIG. 4B is a diagram showing the control configuration of the sound control system in the situation where a noise source is inside a building.

[FIG. 5] FIG. 5 is a diagram showing an internal structure of a control filter.

[FIG. 6A] FIG. 6A is a graph plotting control effects of the sound control system.

[FIG. 6B] FIG. 6B is a graph plotting control effects of the sound control system.

[FIG. 6C] FIG. 6C is a graph plotting control effects of the sound control system.

[FIG. 7A] FIG. 7A is a graph plotting control effects of the sound control system.

[FIG. 7B] FIG. 7B is a graph plotting control effects of the sound control system.

[FIG. 7C] FIG. 7C is a graph plotting control effects of the sound control system.

[FIG. 8A] FIG. 8A is a graph plotting control effects of the sound control system.

[FIG. 8B] FIG. 8B is a graph plotting control effects of the sound control system.

[FIG. 8C] FIG. 8C is a graph plotting control effects of the sound control system.

[FIG. 9A] FIG. 9A is a graph plotting control effects of the sound control system.

[FIG. 9B] FIG. 9B is a graph plotting control effects of the sound control system.

[FIG. 9C] FIG. 9C is a graph plotting control effects of the sound control system.

[FIG. 10A] FIG. 10A is a graph plotting control effects of the sound control system.

[FIG. 10B] FIG. 10B is a graph plotting control effects of the sound control system.

[FIG. 10C] FIG. 10C is a graph plotting control effects of the sound control system.

[FIG. 11A] FIG. 11A is a diagram showing another control configuration of the sound control system according to the first embodiment of the present invention.

[FIG. 11B] FIG. 11B is a diagram showing the control configuration of the sound control system according to the first embodiment of the present invention.

[FIG. 12] FIG. 12 is a diagram showing another application of the sound control system according to the first embodiment of the present invention.

[FIG. 13A] FIG. 13A is a diagram showing a structure of a speaker in a sound control system according to a second embodiment of the present invention.

[FIG. 13B] FIG. 13B is a diagram showing another structure of the speaker in the sound control system according to the second embodiment of the present invention.

[FIG. 13C] FIG. 13C is a diagram showing still another structure of the speaker in the sound control system according to the second embodiment of the present invention.

[FIG. 14A] FIG. 14A is a diagram showing an example of an arrangement of error microphones.

[FIG. 14B] FIG. 14B is a diagram showing an example of an arrangement of error microphones.

[FIG. 14C] FIG. 14C is a diagram showing an example of an arrangement of an error microphone.

[FIG. 15] FIG. 15 is a diagram showing a first conventional art.

[FIG. 16] FIG. 16 is a diagram showing another configuration of the first conventional art.

[FIG. 17] FIG. 17 is a diagram showing an internal structure of a control filter shown in FIG. 16.

[FIG. 18] FIG. 18 is a diagram showing a second conventional art.

[FIG. 19] FIG. 19 is a diagram showing an example of an arrangement of a speaker and an error microphone according to the second conventional art.

[FIG. 20] FIG. 20 is a diagram showing a situation where a noise source is outside a house.

[FIG. 21] FIG. 21 is a diagram showing a situation where a noise source is inside a house.

[FIG. 22A] FIG. 22A is a diagram showing an audio simulation model based on the situation in FIG. 21.

[FIG. 22B] FIG. 22B is a diagram showing an audio simulation model based on the situation in FIG. 21.

[FIG. 23] FIG. 23 shows graphs each plotting analysis results.

[FIG. 24] FIG. 24 shows graphs each plotting analysis results.

[FIG. 25] FIG. 25 shows graphs each plotting analysis results.

[FIG. 26] FIG. 26 shows graphs each plotting analysis results.

[FIG. 27] FIG. 27 shows graphs each plotting analysis results.

[FIG. 28] FIG. 28 is a diagram showing an audio simulation model for comparing various sound pressure distribution of a speaker having a diameter of 5 cm.

[FIG. 29] FIG. 29 shows graphs each plotting analysis results.

[FIG. 30] FIG. 30 is a diagram showing an audio simulation model for comparing various sound pressure distribution of a speaker having a diameter that is varied.

[FIG. 31] FIG. 31 shows graphs each plotting analysis results.

[FIG. 32A] FIG. 32A is a diagram showing a configuration in an experiment for examining how a speaker distance influences effects.

[FIG. 32B] FIG. 32B is a diagram showing a structure in an experiment for examining how a speaker distance influences effects.

[FIG. 33A] FIG. 33A is a graph plotting experimental results.

[FIG. 33B] FIG. 33B is a graph plotting experimental results.

[FIG. 33C] FIG. 33C is a graph plotting experimental results.

[FIG. 33D] FIG. 33D is a diagram showing experimental results.

[FIG. 34A] FIG. 34A is a graph plotting experimental results.

[FIG. 34B] FIG. 34B is a graph plotting experimental results.

[FIG. 34C] FIG. 34C is a graph plotting experimental results.

[FIG. 34D] FIG. 34D is a diagram showing experimental results.

[FIG. 35A] FIG. 35A is a graph plotting experimental results.

[FIG. 35B] FIG. 35B is a graph plotting experimental results.

[FIG. 35C] FIG. 35C is a graph plotting experimental results.

[FIG. 35D] FIG. 35D is a diagram showing experimental results.

[FIG. 36] FIG. 36 shows diagrams schematically showing the graphs in FIG. 23.

[FIG. 37] FIG. 37 shows diagrams schematically showing the graphs in FIG. 24.

[FIG. 38] FIG. 38 shows diagrams schematically showing the graphs in FIG. 25.

[FIG. 39] FIG. 39 shows diagrams schematically showing the graphs in FIG. 26.

[FIG. 40] FIG. 40 shows diagrams schematically showing the graphs in FIG. 27.

[FIG. 41] FIG. 41 shows diagrams schematically showing the graphs in FIG. 29.

[FIG. 42] FIG. 42 is a diagram schematically showing the diagram in FIG. 30.

[FIG. 43] FIG. 43 shows diagrams schematically showing the graphs in FIG. 31.

[FIG. 44] FIG. 44 is a diagram showing a speaker and the like.

[FIG. 45] FIG. 45 shows graphs each plotting sound pressure data.

[FIG. 46] FIG. 46 shows graphs each plotting sound pressure data.

[FIG. 47] FIG. 47 shows graphs each plotting sound pressure data.

[FIG. 48] FIG. 48 is a diagram showing two speakers and the like.

[FIG. 49] FIG. 49 is a diagram showing a speaker and the like.

[FIG. 50] FIG. 50 is a diagram showing a newly building house and the like.

[FIG. 51] FIG. 51 shows diagrams schematically showing the graphs in FIG. 45.

[FIG. 52] FIG. 52 shows diagrams schematically showing the graphs in FIG. 46.

[FIG. 53] FIG. 53 shows diagrams schematically showing the graphs in FIG. 47.

### BEST MODE FOR CARRYING OUT THE INVENTION

The following describes embodiments of the present invention with reference to the drawings.

A speaker 10 according to the embodiments of the present invention includes a speaker unit 20, a passive radiator 50x, and a cabinet 30. The passive radiator 50x is provided in front of the speaker unit 20. An example of the passive radiator 500 is shown in FIG. 14A. The speaker unit 20 is provided in the cabinet 30 as shown in FIG. 1A. Since the speaker unit 20 is stored in the cabinet 30, the cabinet 30 covers a back space behind the speaker unit 20. The cabinet 30 is adjacent to a cabinet storing the passive radiator 50x, so that a space 30x (shown in FIG. 3) between the speaker unit 20 and the passive radiator 50x is sealed. The passive radiator 50x has an effective piston area 50L as shown in FIG. 14A which is larger than an effective piston area 20L of the speaker unit 20. An example of the speaker unit 20 is a driver.

In the following description, a TV 4 is shown in FIG. 3 and the like. The TV 4 is an example of an audio apparatus used in an external space 6x to emit sound. The audio apparatus is not limited to the shown TV 4, but may be a stereo apparatus or a musical instrument, or the like.

More specifically, for example, the effective piston area 50L, shown in FIG. 14A, of the passive radiator 50x is not smaller than twice as large as the effective piston area 20L of the speaker unit 20.

A control point 60P is positioned very close to the speaker, being far from the speaker by a distance 1n. An effect sensor such as an error microphone 60 is provided at the control point 60P to detect effects of control performed by a sound control system 1s. A control filter 110 adjusts its control characteristics depending on a signal provided from the effect sensor.

Here, the distance 1n between the speaker 10 and the control point 60P at which the effect sensor such as the error microphone 60 is arranged is equal to or less than a diameter of the speaker unit 20. The diameter is a diameter x shown in FIG. 4A.

In the above configuration, a position of the effect sensor such as the error microphone 60 is arranged very close to the speaker 10, namely, a wall 3. For example, the effect sensor is far from the speaker 10 by the above-mentioned distance 1n. As a result, it is possible to prevent the effect sensor from obstructing a user moving around in the space 6 as shown in FIG. 4A, for example. Therefore, the configuration of the sound control system 1s including the speaker 10 is appropriate not to obstruct the user moving around in the space 6.

For example, the speaker 10 as shown in FIG. 3 is embedded in the wall 3 in a house 1. The wall 3 separates an whose space into the space 6 and an external space 6x outside the space 6. The external space 6x is a space in which the audio apparatus such as the TV 4 exists to emit sound. The space 6, which is not the external space 6x where the audio apparatus is provided, is a space where the user (not shown) listening to the sound.

The sound control system 1s as shown in FIG. 4A including the speaker 10 also includes an error microphone such as the error microphone 60 shown in FIG. 4A. The error microphone detects sound in the space 6 where the user exists.

The speaker 10 causes the speaker unit 20 as shown in FIG. 3 to reproduce sound to be provided to the space 6x where the user exists.

The sound detected by the error microphone includes noise caused by sound reproduction of the audio apparatus such as the TV4. The sound is controlled to include noise less than original noise.

A distance from the speaker 10 (namely, the wall 3) to the error microphone is the first distance 1n. The first distance 1n is shorter than a second distance 1f shown in FIG. 4A. While the second distance 1f is appropriate in the case where the passive radiator 50x as shown in FIG. 3 is not provided in the speaker 10, the first distance 1n is appropriate in the case where the passive radiator 50x is provided in the speaker 10. If an error microphone is arranged at a position far from the speaker 10 by the second distance 1f, the error microphone is likely to obstruct the user moving in the space 6. If the error microphone is arranged at a position far from the speaker 10 by the first distance 1n, the error microphone is unlikely to obstruct the user.

For the above reason, the space 6, to which the sound emitted by the speaker 10 is propagated and in which the error microphone is provided, is considered as a three-dimensional space where a person exists, not a one-dimensional space such as a space in the duct 1000 shown in FIG. 15.

The passive radiator 50x is provided in such a speaker 10. The error microphone is arranged to be far from the wall 3 by the relatively short first distance 1n.

In the above configuration, the error microphone does not obstruct the path of the user in the space 6 so that the user can easily move around in the space 6. Therefore, the error microphone is arranged at an appropriate position, so that the sound control system 1s has an appropriate configuration.

As described earlier, the effective piston area 50L shown in FIG. 4A of the passive radiator is not smaller than twice as large as the effective piston area 20L of the speaker unit such as a driver. Therefore, the above-described first distance 1n is short enough to appropriately implement the sound control system which the user desires.

It should be noted that the passive radiator 50x is made of a material causing the sound control system to offer enough high performance, for example, good quality of emitted sound. For example, the passive radiator 50x is made of a material except a metal.

### First Embodiment

The following describes a configuration of the sound control system according to the first embodiment of the present invention.

Each of FIGS. 1A to 1C shows a structure of the speaker in the sound control system according to the first embodiment of the present invention.

The left-side diagram in FIG. 1A is a front view of the speaker 10 in which the speaker unit 20 is provided in the cabinet 30. The right-side diagram in FIG. 1A is a cross-sectional view of the speaker 10.

The speaker unit 20 includes a diaphragm and a magnetic circuit. If the speaker unit 20 is not stored in the cabinet 30, sound emitted from the font surface of the diaphragm and sound emitted from the rear surface of the diaphragm cancel each other not to produce low-pitched sound. Therefore, the speaker unit 20 is provided inside the cabinet 30. It should be noted that the cabinet 30 shown in FIGS. 1A to 1C is a sealed cabinet. However, the cabinet 30 is not limited to the above, but may be any cabinet, such as a bass reflex cabinet, depending on application situation. The speaker 10 is generally referred to as a speaker system.

The left-side diagram in FIG. 1B is a front view of a plurality of passive radiators 50 to 54 provided in a cabinet 40. The right-side diagram in FIG. 1B is a cross-sectional view of the cabinet 40. The rear surface of the cabinet 40 is an opening.

The left-side diagram in FIG. 1C is a front view of the speaker 10 in which the plurality of passive radiators 50 to 54 provided in the cabinet 40 shown in FIG. 1B is attached to the cabinet 30 including the speaker unit 20 shown in FIG. 1A. The right-side diagram in FIG. 1C is a cross-sectional view of the speaker 10.

The cabinet 30 and the cabinet 40 are attached to each other to form a sealed space as shown in the left-side and right-side diagrams in FIG. 1C. In other words, the space serves as a volumetric capacity behind the passive radiators 50 to 54. With the above structure, as the speaker unit 20 moves, the air confined in the cabinets 30 and 40 moves the passive radiators 50 to 54. This means that the speaker 10 serves as a Kelton speaker using the passive radiators. The Kelton speaker is applied to a woofer.

Here, the speaker unit 20 is small as much as possible and thin. The cabinet 30 has a depth that is thin as much as possible. The cabinet 40 has a depth that is thin as much as possible. However, it is necessary to ensure performance for reproducing low-pitched sound required to produce sound-field control effects.

As described above, the speaker unit 20 is thin, the cabinet 30 is thin, and the cabinet 40 is thin because the passive radiators 50 to 54 do not include a magnetic circuit. As a result, the speaker 10 is also thin. Therefore, as shown in FIGS. 2 and 3, the speaker 10 can be embedded in the wall 3.

FIG. 2 is a diagram showing a situation where a noise source 2 is outside a house.

FIG. 3 shows a situation where a speaker 5 in a TV 4 is inside the house and produces noise as a noise source.

In both situations shown in FIGS. 2 and 3, the noise enters a to-be-controlled space (the space 6) via the wall 3. The following describes a control method according to the present embodiment in more detail with reference to FIG. 3 in addition to FIGS. 4A, 4B, and 5.

Each of FIGS. 4A and 4B is a diagram showing a control configuration of the sound control system according to the first embodiment, when the noise source is inside the house.

As shown in FIG. 4A, the speaker 10 and another speaker 11 are adjacent to each other as shown in FIG. 4B in the wall 3. Here, the speaker 11 has the same structure as the speaker 10 according to the embodiment of the present embodiment.

As described with reference to FIGS. 1A to 1C, the speaker 10 includes a plurality of passive radiators 50 to 54 shown in FIG. 4B and the like in front of the speaker unit 20 shown in FIG. 5. Likewise, the speaker 11 includes a plurality of passive radiators 55 to 59 shown in FIG. 4B and the like in front of the speaker unit 21 shown in FIG. 5.

Each of error microphones 60 to 69 is provided close to the center of a corresponding one of the passive radiators 50 to 59, as being far from the corresponding passive radiator by approximately 2 cm.

In the above configuration, sound emitted from the speaker 5 in the TV 4 shown in FIG. 4A reaches the error microphones 60 to 69 via the wall 3. Furthermore, the sound emitted from the speaker 5 in the TV 4 is detected by a noise microphone 100 and provided to the control filter 110.

The control filter 110 includes, as shown in FIG. 5, the FIR filters 111 and 112, the Fx filters 113 to 116, the LMS calculators 117 to 120, and the coefficient adders 121 and 122.

Each of the FIR filters 111 and 112 performs convolution on a noise signal provided from the noise microphone 100 and a coefficient set in the filter. Then, the FIR filter 111 provides the speaker 10 with a control signal that is the signal for which the convolution has been performed, and the FIR filter 112 provides the speaker 11 with a control signal that is the signal for which the convolution has been performed.

The Fx filter 113 has a coefficient generated by approximating propagation characteristics of propagation from the speaker 10 to the adder 101 via the error microphones 60 to 64.

Likewise, the Fx filter 114 has a coefficient generated by approximating propagation characteristics of propagation from the speaker 10 to the adder 102 via the error microphones 65 to 69. The Fx filter 115 has a coefficient generated by approximating propagation characteristics of propagation from the speaker 11 to the adder 101 via the error microphones 60 to 64. The Fx filter 116 has a coefficients generated by approximating propagation characteristics of propagation from the speaker 11 to the adder 102 via the error microphones 65 to 69.

Each of the Fx filters 113 to 116 performs convolution on the noise signal provided from the noise microphone 100 and the corresponding coefficient. The Fx filters 113 to 116 provides the respective convolution results to the LMS calculators 117 to 120, respectively.

The LMS calculator 117 receives, as an error signal, a signal detected by the adder 101, and performs LMS arithmetic operation on the received error signal with reference to the signal provided from the Fx filter 113. The LMS calculator 118 receives, as an error signal, a signal detected by the adder 102, and performs LMS arithmetic operation on the received error signal with reference to the signal provided from the Fx filter 114. The LMS calculator 119 receives, as an error signal, a signal detected by the adder 101, and performs LMS arithmetic operation on the received error signal with reference to the signal provided from the Fx filter 115. The LMS calculator 120 receives, as an error signal, a signal detected by the adder 102, and performs LMS arithmetic operation on the received error signal with reference to the signal provided from the Fx filter 116.

Then, a coefficient adder 121 sums the results of the LMS arithmetic operations of the LMS calculators 117 and 118, in order to update the coefficient set in the FIR filter 111. A coefficient adder 122 sums the results of the LMS arithmetic operations of the LMS calculators 119 and 120, in order to update the coefficient set in the FIR filter 112.

A sequence of the generation of the control signals in the

FIR filters 111 to 112 and the updating of the coefficients is repeated to reduce noise by the two speakers 10 and 11 at two control points that are the adders 101 and 102.

Here, the passive radiators 50 to 54 in the speaker 10 shown in FIG. 4B are driven by the same speaker unit 20. Therefore, the passive radiators 50 to 54 oscillate in the same way with the same phase. However, a distance between the speaker unit 20 and each of the passive radiators 50 to 54 is varied as being short or long, depending on each of the passive radiators 50 to 54, as shown in FIGS. 4A, 5, and the like. They therefore oscillate not completely in the same way. As a result, signals detected by the error microphones 60 to 64 have the almost same characteristics, but are slightly different.

In order to smooth the slight variation, the adder 101 sums the signals detected by the error microphones 60 to 64 to average the signals.

As described earlier with reference to FIGS. 30 and 31, the provision of the passive radiators 50 to 54 can produce effects equivalent to those in the situation where a size of the diaphragm (namely, a diameter) of the speaker unit 20 is increased. Therefore, effects (characteristics) detected in just front of the passive radiators 50 to 54 are smoothed to be homogeneous.

In addition, the provision of the error microphones 60 to 64 and the adder 101 can average and homogenize the slight variation among the detected signals.

Likewise the speaker 10, the speaker 11 can produce the same effects. The provision of the passive radiators 55 to 59, the error microphones 65 to 69, and the adder 102 can average and homogenize signals detected in just front of the passive radiators 55 to 59 to be homogeneous.

Therefore, if the error signal generated by each of the adders 101 and 102 is reduced, the noise in just front of the passive radiators 50 to 59 is controlled homogeneously.

Each of FIGS. 6A to 6C, 7A to 7C, 8A to 8C, 9A and 9C, and 10A to 10C is a graph plotting effects of noise reduction control by the sound control system shown in FIGS. 4A and 4B.

Each of FIGS. 6A to 10C shows the noise reduction effects measured in actual experiments. Here, each of the employed speakers 10 and 11 includes: the speaker unit having a diameter of 7 cm; and the passive radiators 50 to 59 each having dimensions of height 3 cm×wide 15 cm. A distance between the speakers 10 and 11 is 20 cm as shown in FIG. 4A. Dimensions of each of the speakers 10 and 11 are height 22 cm×wide 20 cm×depth 6 cm.

FIG. 6A shows noise reduction effects detected by the error microphone 60 for the speaker 10. FIG. 6B shows noise reduction effects detected by the error microphone 65 for the speaker 11. FIG. 6C shows noise reduction effects detected by the evaluation microphone 130 arranged between the speaker 10 and the speaker 11.

Likewise, FIG. 7A shows noise reduction effects detected by the error microphone 61 for the speaker 10. FIG. 7B shows noise reduction effects detected by the error microphone 66 for the speaker 11. FIG. 7C shows noise reduction effects detected by the evaluation microphone 131 arranged between the speaker 10 and the speaker 11.

Likewise, FIG. 8A shows noise reduction effects detected by the error microphone 62 for the speaker 10. FIG. 8B shows noise reduction effects detected by the error microphone 67 for the speaker 11. FIG. 8C shows noise reduction effects detected by the evaluation microphone 132 arranged between the speaker 10 and the speaker 11.

Likewise, FIG. 9A shows noise reduction effects detected by the error microphone 63 for the speaker 10. FIG. 9B shows noise reduction effects detected by the error microphone 68 for the speaker 11. FIG. 9C shows noise reduction effects detected by the evaluation microphone 133 arranged between the speaker 10 and the speaker 11.

Likewise, FIG. 10A shows noise reduction effects detected by the error microphone 64 for the speaker 10. FIG. 10B shows noise reduction effects detected by the error microphone 69 for the speaker 11. FIG. 10C shows noise reduction effects detected by the evaluation microphone 134 arranged between the speaker 10 and the speaker 11.

The noise reduction effects are calculated by a difference between results in the case where the noise reduction control is not performed (OFF) and results in the case where the noise reduction control is performed (ON). A level of 0 dB or more is considered as an amount of the noise reduction. At a frequency is 60 Hz or lower, performance of low-pitched sound reproduction by each of the employed speakers 10 and 11 is not enough. Therefore, at a frequency of 60 Hz or lower of the low-pitched sound reproduction performance, it is impossible to reproduce a sound pressure much greater than that of dark noise in the measured sound field. In other words, a frequency of 60 Hz or lower cannot ensure an enough Signal-to-Noise ratio (S/N). Therefore, noise reduction effects are achieved at a frequency of 60 Hz or higher.

As described above, each of the effects shown in FIGS. 7C, 8C, and 9C detected by the evaluation microphones 131 to 133 shown in FIG. 4B is equivalent to the effects detected by corresponding error microphones among the error microphones 61 to 63 and 66 to 63 shown in FIGS. 7A, 8A, and 9A, and FIGS. 7B, 8B, and 9B. Each of the effects detected by the evaluation microphones 130 and 134 as shown in FIG. 6C and 10C is slightly deteriorated in comparison to corresponding effects of the effects detected by corresponding error microphones from among the error microphones 60, 64, 65, and 69 shown in FIGS. 6A, 10A, 6B, and 10B. However, the deterioration shown in FIG. 6C and 10C are less than the deterioration shown in FIG. 35A to 35D, although each of the distances among the error microphones is longer than the case of FIG. 35A to 35D. For example, the noise reduction effects shown in FIG. 8C detected by the evaluation microphone 132 are compared to the conventional noise reduction effects detected by the evaluation microphone 1400 shown in FIG. 35D. In this case, although the distance among the error microphones in the experiment using the evaluation microphone 132 is 1.5 times as long as the distance among the error microphones in the experiment using the evaluation microphone 1400, the noise reduction effects detected by the evaluation microphone 132 is higher than the noise reduction effects detected by the evaluation microphone 1400. This means that the noise reduction effects in the case shown in FIGS. 4A to 10C are higher than the noise reduction effects in the case shown in FIGS. 35A to 35D. The above analysis results show that noise can be homogeneously reduced on the entire front surface of each of the speakers 10 and 11.

Each of FIG. 11A and 11B shows another configuration of the sound control system according to the first embodiment of the present invention.

In the above-described configuration with reference to FIGS. 4A to 10C, noise is controlled at two points that are the adders 101 and 102 by using two speakers that are the speakers 10 and 11. On the other hand, in this configuration shown in FIGS. 11A and 11B, noise is controlled at four points by using four speakers of speakers 12 and 13 in addition to the speakers 10 and 11. Here, the speakers 11. and 12 have the same structure as that of the speakers 10 and 11 according to the embodiment of the present embodiment. This configuration is merely a double of the configuration shown in FIG. 4B. Therefore, the internal structure of the control filter 110 is expanded to correspond to the doubled configuration. Thereby, the number of speakers can be easily increased. If a large number of the speakers is scattered in the wall 3, noise can be reduced in the entire wall 3.

As described above, the provision of the speaker unit having a small diameter, in other words, the provision of the small, thin, and light speaker unit can allow the speaker to be manufactured to be light and thin to be easily embedded in a general wall.

In addition, the provision of the passive radiators can increase the diameter of the same light and thin speaker. As a result, it is possible to homogenize the speaker characteristics (noise reduction effects) detected at the position in just front of the speaker.

Furthermore, the provision of the plurality of error microphones can detect slight variation of homogenized signals of the passive radiators. The detected various signals are added together, and homogenized and averaged. As a result, even if a size of the speaker is increased, the noise reduction effects can be achieved under opposite conditions in which noise is homogeneously controlled in just front of the speaker.

Moreover, even if a plurality of error microphones are provided, the signals detected by the error microphones are summed to reduce an arithmetic operation amount. In addition, a size of the speaker is increased to decrease the number of the speaker provided in the entire wall. As a result, the arithmetic operation amount can be significantly reduced.

It should be noted in the first embodiment that each of the error microphones is arranged in just front of the corresponding speaker. However, in the situation where noise is emitted from a location outside the to-be-controlled space as shown in FIG. 2, it is difficult to specify a noise source of the noise. In order to solve the problem, adaptive control is to be performed to change the control characteristics of the control filter 110 depending on the situation. Therefore, an error microphone is necessary. However, if it is possible to determine a position of the sound source such as the TV in FIG. 3, the control characteristics of the control filter 110 are predetermined so that the error microphone does not always need. However, under the assumption that audio characteristics between a speaker and an error microphone are varied depending on, for example, a re-arrangement of the to-be-controlled space, it is desirable to provide the error microphone.

It should also be noted that it has been described that the speaker 10 includes the dedicated cabinets 30 and 40 to serve as an independent speaker system. However, if the speaker 10 is embedded in the wall 3, the wall 3 may include the cabinets 30 and 40.

It should also be noted that it has been described that each of the error microphones 60 to 69 is arranged far from a corresponding one of the speakers 10 and 11 by 2 cm. However, the arrangement is not limited to the above. Any arrangement is possible as long as the predetermined object is achieved and the desired noise reduction effects can be produced.

As described in the first embodiment, if each of the error microphones 60 to 69 is arranged close to a corresponding one of the speakers 10 and 11, in other words, if the error microphones 60 to 69 are arranged very close to the wall 3, the error microphones may be provided inside the wall 3. In this case, a space offered with the noise reduction effects can be enlarged, and the error microphones 60 to 69 do not obstruct moving people, packages, and equipment in the to-be-controlled space 6.

On the contrary, if each of the error microphones 60 to 69 is far from a corresponding one of the speakers 10 and 11 by a rather long distance, target sound is detected at the position where a wave field of reproduction sound emitted from the speakers 10 and 11 is further homogenized. Therefore, if the same number of error microphones is used, this case can improve the noise reduction effects. Or, if the same noise reduction effects as those in the case where the error microphones are arranged close to the speakers are desired, it is possible to decrease the number of error microphones.

FIG. 12 is a diagram showing still another configuration of the sound control system according to the first embodiment of the present invention.

The object of the first embodiment is to reduce noise emitted from a sound source inside or outside the to-be-controlled space. The first embodiment may be applied to the situation shown in FIG. 12 where someone watches TV or listens to music. In other words, as shown in FIG. 12, a room where the TV exists is the to-be-controlled space 6. The speakers 10 and 12 are embedded in the wall 3. Speakers 14 and 16, which have the same structure as that of the speakers 10 to 14 according to the first embodiment, are embedded in a wall 7 in the house 1. The sound control having the above configuration may be applied to control sound to provide good-quality audio characteristics in the entire room.

With the above configuration, not only a person in front of the center of the TV but also people around the TV can enjoy the same good-quality audio characteristics. The good-quality audio characteristics refer to, for example, sound localization, sound field control such as surround for improving sound reality, sound quality adjustment for improving quality of low-pitched sound, and the like. Especially, conventional technologies of improving sound reality, such as stereophony and 3D sound (surround sound), have a problem of extremely narrow sweet spot. By the conventional technologies, only one person at a sweet spot can perceive optimum audio characteristics. However, the first embodiment of the present invention can allow all people (all family members) in a target room to perceive the same optimum audio characteristics.

FIG. 44 is a diagram showing the speaker 10 and the like.

Each of FIGS. 45 to 47 shows graphs plotting sound pressures.

In each of the upper graphs in FIG. 45, data at a frequency of 100 Hz is shown. In each of the lower graphs in FIG. 45, data at a frequency of 200 Hz is shown. In each of the upper graphs in FIG. 46, data at a frequency of 300 Hz is shown. In each of the lower graphs in FIG. 46, data at a frequency of 400 Hz is shown. FIG. 47 shows data at a frequency of 500 Hz.

At each frequency, three kinds of graphs are shown at the left-hand side, the center, and the right-hand side of the corresponding figure. More specifically, the graph at the left-hand side among the three kinds of graphs plots the situation where the speaker 10 has a diameter x (see FIGS. 44, 4A, and the like) of 5 cm. The graph at the center plots the situation where the speaker 10 has a diameter x of 15 cm. The graph at the right-hand side plots the situation where the speaker 10 has a diameter x of 30 cm.

A chain line shown in FIG. 44 shows a center line of the speaker 10.

A vertical axis in each of the graphs at a corresponding frequency and with a corresponding diameter x represents a distance from the speaker 10 as shown in FIG. 44 to a target observation plane in parallel to the center line. Data on the vertical axis is measured in centimeter.

FIG. 44 shows variations of a distance from the speaker 10, such as a distance of 1 cm from the speaker 10 to a plane A and a distance of 2 cm from the speaker 10 to a plane B.

Each of the graphs shows a sound pressure with reference to a sound pressure at a target point (shown as a circle in FIG. 44) on a target plane (such as the plane A or the plane B) along the center line.

In other words, a horizontal axis in each of the graphs represents a position in a direction parallel to the target plane, namely, a position in a direction perpendicular to the above-described center line.

In each of the graphs, a sound pressure at each position on the horizontal axis is shown with reference to a sound pressure at a position (circle in FIG. 44) on the above-described center line. Data on the horizontal axis is measured in decibel (db).

The graphs show the following results, regardless of a size of the diameter x of the speaker 10, such as 5 cm, 15, cm, or 30 cm, and regardless of the frequency such as 100 Hz, 200 Hz, . . . .

In other words, with any diameter size and any frequency, a diameter (a length in a direction of the horizontal axis in the area 1 in each graph shown in FIG. 45) in the area 1. having a sound pressure ranging from 0 db to −1.5 db is equal to or longer than the diameter x of the speaker 10, only when a distance represented on the vertical axis is longer than the diameter x.

For example, from among the three kinds of graphs at different frequencies, the graph at the left-hand side regarding the diameter x of 5 cm shows that the diameter of the area 1 is 5 cm or more only when a target plane is at a position (a position above a broken line in the graph) having a distance longer than a distance of 5 cm shown by the broken line.

Here, the distance 1f shown in FIG. 4A is a distance from the speaker 10 to the error microphone is arranged, in a conventional art except the present invention.

In other words, for example, the distance 1f according to the conventional art is a distance that is longer than the diameter x (for example, 5 cm) so that the error microphone is far from the speaker 10 by the long distance.

In short, for example, the distance 1f according to the conventional art is “distance 1f>diameter x”.

Therefore, in the conventional art, the error microphone very far from the speaker 10 by the distance 1f obstructs the user moving in the space 6 as shown in FIG. 3, for example.

On the other hand, according to the first embodiment of the present invention, the passive radiator such as the passive radiator 500 shown in FIG. 14A is provided in the speaker 10. As shown in FIG. 14A, an effective area 50L of the passive radiator is larger than an effective area 20L of the speaker unit 20 as shown FIG. 3.

With the above structure, for example, the distance 1n shown in FIG. 4A, which is assumed to be a distance from the speaker 10 to the error microphone such as the error microphone 60 as shown in FIG. 3, satisfies “distance 1n≦diameter x”. As a result, the error microphone is not very far from the speaker 10 by the distance 1n.

Thereby, it is possible to prevent the error microphone from obstructing the user moving around in the space 6, for example. It is also possible to allow the sound control system 1s shown in FIG. 4A to have appropriate configuration not to obstruct the user and the like.

FIGS. 51 to 53 are diagrams of FIGS. 45 to 47 described earlier, respectively. FIGS. 51 to 53 should be referred to as needed.

FIG. 48 shows a conventional art different from the first embodiment of the present invention.

FIG. 49 shows a configuration of the first embodiment of the present embodiment.

As shown in FIG. 48, in the conventional art, it is assumed that appropriate noise reduction effects should be detected at an evaluation point 486p. Under the assumption, if only small speakers 484 and 485 are used, these small speakers are arranged adjacent to each other. In addition, two control filters 482 and 483 are necessary to control noise at two control points 484p and 485p.

On the other hand, as shown in FIG. 49, the first embodiment of the present invention has a different configuration. In the first embodiment, a passive radiator such as the passive radiator 500 is employed to increase an area of a diaphragm.

With the above configuration, a control point serves also as an evaluation point (or, output signals of a plurality of control points may be summed). As a result, each of the number of speakers and the number of control filters is decreased to one half of the number in the conventional configuration shown in FIG. 48 (by a reduction width of ½ times). For example, the number is two in the configuration of FIG. 49, while it is one in the configuration of FIG. 48.

Likewise, in comparison to the conventional configuration using three small speakers, the configuration shown in FIG. 49 can decrease each of the number of speakers and the number of control filters to one third (by a reduction width of ⅓ times).

Among ½ times and ⅓ times of a reduction width of an arithmetic operation amount, ½ times is closer to one time. Therefore, it is desirable to reduce the arithmetic operation amount by a reduction width of ½ times or more.

Therefore, in the first embodiment of the present invention, the effective area 50L (the area 1z) of the passive radiator shown in FIG. 14A and the effective area 20L (the area 1x) of the speaker unit 20 satisfy a relationship “area 1x/ area 1z≧2”. In other words, the area 1x of the passive radiator should be not smaller than twice as large as the area 1x of the speaker unit 20.

With the above configuration, the effective area 50L (the area 1x) of the passive radiator is appropriate and large enough to realize the desired reduction width.

### Second Embodiment

The following describes a configuration of a sound control system according to the second embodiment of the present invention.

Each of FIGS. 13A to 13C shows a structure of a speaker in the sound control system according to the second embodiment of the present invention.

The speaker structure according to the second embodiment shown in FIGS. 13A to 13C differs from the speaker structure according to the first embodiment shown in FIGS. 1A to 1C in that the passive radiators 50 to 54 shown in FIGS. 16 and 1C are replaced by a single passive radiator 500. Except the above difference, the speaker structure shown in FIGS. 13A to 13C is the same as the speaker structure shown in FIGS. 1A to 1C.

The difference of second embodiment has advantages of decreasing the number of passive radiators to eventually decrease a cost.

FIGS. 14A to 14C show various arrangements of error microphones for the speaker shown in FIGS. 13A to 13C.

Here, a rigidity of the passive radiator 500 influences noise reduction control. Ideally, relatively preferable operation of the passive radiator 500 is piston oscillation. When the passive radiator 500 performs piston oscillation, homogenous sound can be expected even at a position very close to the passive radiator 500. In order to achieve this, the passive radiator 500 should have a high rigidity. However, if the rigidity is increased, the passive radiator 500 is generally heavier having a difficulty in reproducing low-pitched sound with enough sound pressure. Therefore, if the speaker is made of a common material having an appropriate internal loss, the reproduced sound very close to the passive radiator 500 is likely to have an unsteady wave field. Therefore, the error microphones are arranged as shown in FIGS. 14A to 14C.

The arrangement of the error microphones shown in FIG. 14A is the same as the arrangement shown in FIG. 4A or the like. In this arrangement, an employed control method is the same as the method described in the first embodiment, namely, the method of summing output signals of the error microphones 60 to 64 to generate an error signal. Since the method has previously been described in detail, it will not be explained again below.

FIG. 14B shows another arrangement in which the error microphones 60 to 64 are dispersed at the center and four corners of the passive radiator 500. A control method employed in this arrangement is the same as the method described in the first embodiment, namely, the method of summing output signals of the error microphones 60 to 64 to generate an error signal.

Selection between the arrangement shown in FIGS. 14A and the arrangement shown in FIG. 14B may depends on an unsteady state of a wave field of reproduced sound detected at a position very close to the passive radiator 500. It should be noted that any arrangement of the error microphones may be possible if the sound control effects (noise reduction effects) can be offered.

FIG. 14C shows still another arrangement in which only the error microphone 60 is arranged at the center of the passive radiator 500. As described above, this arrangement has no problem if the passive radiator 500 has a high rigidity and performs piston oscillation. This arrangement decreases the number of error microphones, thereby reducing a cost.

As described above, if a plurality of passive radiators are replaced by a single passive radiator, it is possible to reduce a cost. In addition, if the number and an arrangement of error microphones are determined depending on a unsteady state of a wave field of reproduction sound detected at a position very close to the passive radiator 500, it is possible to surely control sound (reduce noise) and reduce a cost.

However, if a large passive radiator, such as the passive radiator 500 shown in FIG. 14C, is required and the provision of such a large passive radiator is a new factor of increasing a cost (for example, if such large passive radiators are not mass-manufactured and it is therefore necessary to invest in a new mold of the desired passive radiator), provision of a plurality of existing passive radiators (for example, a part of a great number of existing passive radiators manufactured for TV and currently in the marketplace) results in a lower cost. In the case of using a plurality of existing passive radiators, the speaker may have the structure as described in the first embodiment of the present invention.

It should be noted that various modifications of the first and second embodiments of the present invention are possible.

For example, it is possible to provide a divider in the house 1001 to separate the space 6 from the external space 6x outside the space 6. An example of the divider is the wall 3 in the house 1001 as shown in FIG. 3.

For example, the wall 3 may be a piece that is purchased by the user or a construction company in building the house 1001, and equipped in the house 1001 by the construction company or the like, as shown in FIG. 50.

In other words, the wall 3 may be one of pieces of the house 1001 which are manufactured by a manufacture or the like, and sold to the construction company or the like of the house 1001.

That is, the wall 3 may be a piece sold to the construction company or the like.

For example, the wall 3 may be distributed separately and independently from other pieces of the house 1001.

The divider may not be a wall such as the wall 3 equipped in the house 1001. In other words, for example, the divider may be a well-known partition or any other piece.

Here, the space 6 is a space in which the user exists and listens to sound therein.

For example, the above-described divider such as the wall 3 divides a whole space into two spaces that are the space 6 and the external space 6x outside the space 6.

However, in recent years, most of TVs such as the TV 4 shown in FIG. 3 are very thin.

Therefore, such a very thin TV 4 hanged on the wall 3 as the divider is expected to be widely used more than today in the near future.

In other words, the TV 4 is expected to be often arranged at a position very close to the wall 3. For example, the TV 4 is expected to be in contact with the wall 3.

In order to cope with the above situation, it is possible to embed the speaker 10 as shown in FIG. 3 in the wall 3 (divider) separating the space 6 from other spaces, so that the speaker emits sound to the space 6 in which a person listens to the sound.

In other words, for example, the emitted sound is detected by an error microphone (such as the error microphone 60 in FIG. 14A) and converted to more appropriate sound (such as sound with less noise) listened in the space 6 as shown in FIGS. 3 and 4A.

For example, the speaker 10 may be provided inside the wall 3 to be stored therein.

However, the above configuration has a possibility of causing the following problem.

The speaker 10 should be light enough to be provided in the wall 3.

It is desired that the speaker 10 has a small size enough to cope with a thickness of the wall 3 (see the thickness 1001L in FIG. 22A), for example, to be stored inside the wall 3.

However, if the previously-described diameter of the diaphragm of the speaker unit 20 reproducing sound in the speaker 10 is relatively small, a wave field of sound which is emitted by the speaker 10 and detected at a position in just front of the speaker 10 is not steady, as described earlier.

Here, for example, the relatively small diameter may be 5 cm smaller than 15 cm in the example as shown in FIG. 45 or the like.

The position in just front of the speaker 10 is, for example, a position very close to the speaker 10, such as a position far from the speaker 10 by the distance 1n shown in FIG. 4A.

More specifically, the position in just front of the speaker 10 means a position such that an item such as the error microphone 60 provided at the position is adequately close to the speaker 10 (the wall 3) and therefore does not obstruct the user moving in the space 6, for example.

In other words, if the diameter (diaphragm diameter, effective piston area) of the diaphragm of the speaker unit 20 is relatively small, a wave field of sound detected at a position far from the speaker 10 by the distance 1n is unsteady. Therefore, an error microphone such as the error microphone 60 cannot be arranged at the position.

In this case, the error microphone needs to be arranged far from the speaker 10 by the relatively long distance 1f as shown in FIG. 4A. The error microphone would obstruct the user moving in the space.

In order to solve the above problem, in the embodiment of the prevent invention, the speaker 10 includes the speaker unit 20 and the passive radiator such as the passive radiator 500 as shown in FIG. 13B and the like.

The speaker unit 20 is a driver reproducing sound emitted from the speaker 10.

The passive radiator has a sealed space between the passive radiator and the above-described speaker unit 20. The speaker unit 20 reproduces sound and thereby the passive radiator is oscillated (for example, the previously-described piston oscillation) according to oscillation of the reproduced sound in the sealed space. The oscillation of the passive radiator emits the reproduced sound from the speaker 10.

In order to emit sound, the passive radiator has a diameter (diaphragm diameter) larger than a diameter (diaphragm diameter) of the speaker unit 20.

In other words, the effective piston area 50L of the passive radiator shown in FIG. 14A is larger than the effective piston area 20L of the speaker unit 20, so that the passive radiator emits sound by the large effective piston area 50L.

The passive radiator may be a well-known dron cone or the like.

Thereby, it is possible to keep the diameter of the speaker unit 20 relatively small, and make the speaker 10 light and small enough to be equipped in the wall 3. Thereby, it is possible to provide the speaker 10 in the wall 3 not to cause any trouble. For example, the speaker 10 is unlikely to be detached from the wall 3.

Moreover, when the above-described passive radiator is provided to emit sound, a wave field is steady even at a position very close to the wall 3 (a position far from the speaker 10 by the distance 1n as described earlier).

Thereby, the error microphone such as the error microphone 60 is arranged at a position very close to the speaker 10 where an unsteady wave field does not occur. The error microphone at the position does not obstruct the user moving in the space for example. As a result, the configuration of the sound control system including the speaker 10 is appropriate not to obstruct the user moving and the like.

The above-described speaker 10 is intended to be included within the scope of the present invention. The above-described wall 3 or the divider (divider structure) such as a partition, in which the speaker 10 is provided, is also intended to be included within the scope of the present invention. The sound control system including the speaker 10 is also intended to be included within the scope of the present invention. Any modifications of the embodiments are intended to be included within the scope of the claims.

Since the error microphone is positioned very close to the wall 3 (a position far from the wall 3 by the distance 1n), it is possible to prevent the error microphone from obstructing the user moving in the to-be-controlled space, for example.

On the other hand, in the conventional art using the duct as shown in FIG. 15, a user is not in the space in the duct. Therefore, the error microphone 1200 shown in FIG. 15 cannot be positioned not to obstruct the user moving in the space.

In addition, the space in the duct is a one-dimensional space as described previously, not a three-dimensional space such as a general home room. Therefore, in the conventional art using a duct, quality of detected sound is not (significantly) influenced by a position of the error microphone 1200 shown in FIG. 15. Therefore, the conventional art using a duct has a difficulty in controlling sound by changing a position of the error microphone 1200.

Therefore, those skilled in the art cannot conceive the present invention from the conventional art using a duct as shown in FIG. 15. The present invention has inventive step over the conventional art using a duct as shown in FIG. 15.

For example, the diaphragm of the passive radiator in the speaker 10 is made of a light material enough to cause the above-described operation. For example, the diaphragm of the passive radiator is made of a material except a metal.

In summary, it is possible to provide a low-cost sound control system including a speaker and an error microphone embedded in a wall, so that the speaker and the error microphone do not obstruct a person moving in a room having the wall, and noise is reduced and audio effects are improved in a wide area. More specifically, the sound control system includes: a sound source sensor detecting signals form a sound source; a control filter processing the detected signal; a speaker reproducing output signals of the control filter; and an effect sensor positioned very close to the speaker. Especially, the speaker includes a passive radiator having the same effective piston area as that of a speaker unit. The passive radiator is provided in front of the speaker unit. A plurality of such speakers are embedded in a wall. A plurality of the above-described effect sensors are provided, and output signals of the effect sensors are summed to obtain characteristics of the control filter. Thereby, unsteadiness of a wave field of the reproduced sound detected at a position very close to the speaker is homogenized and averaged, while reducing arithmetic operation load. As a result, it is possible to produce good control effects (noise reduction effects) in the entire to-be-controlled space.

The present invention can be implemented not only as the above-described speaker, but also as the sound control system including the speaker and an integrated circuit included in the speaker or the like. Moreover, the present invention can be implemented also as: a method including steps performed by the speaker, the sound control system, or the like; a program causing a computer to execute the steps; a computer-readable recording medium, such as a Compact Disc-Read Only Memory (CD-ROM), on which the above program is recorded: information, data, signals indicating the program; and the like. The program, information, data, and signals can be distributed by a communication network such as the Internet.

### INDUSTRIAL APPLICABILITY

The sound control system according to the present invention includes a speaker having a size allowing the speaker to be embedded in a wall or partition in order to control sound in just front of the speaker. In addition, the sound control system has acoustic and electrical innovation to reduce arithmetic operation amount even if the entire wall or partition is controlled. As a result, the sound control system can ensure a wide to-be-controlled area surrounded by the wall or partition with a small arithmetic operation amount. The sound control system can be applied in various fields. For example, the sound control system can be applied to audio/visual apparatuses, in-vehicle audio apparatuses, and the like, in order to improve music effects (sound reality, sound quality, and the like). The sound control system can also be applied in residential homes, offices, factories, and the like to reduce noise.

The present invention can provide an appropriate configuration of the sound control system including the speaker not to obstruct the user moving in the to-be-controlled space.

### NUMERICAL REFERENCES

1, 1001 house
2, 2000 noise source
3, 1003, 1004 wall
4, 6000 TV
5, 6100 in-TV speaker
6 to-be-controlled space
10-14, 16, 2300, 2301 speaker
20, 21, 2100, 6200 speaker unit
20L effective piston area
30, 40, 2000a cabinet
30x space
50-59, 50x, 500, 2200 passive radiator
50L effective piston area
60-69, 1200, 1201 error microphone
100, 1100 noise microphone
101-103, 5000 adder
110, 3000 control filter
111, 112, 3100, 3101 FIR filter
113-116, 3200-3203 Fx filter
117-120, 3300-3303 LMS calculator
121, 122, 3400, 3401 coefficient adder
130-134, 1400 evaluation microphone
1000 duct
1002 partition
1500 panel
4000, 4001 person
7000 infinite baffle

1. A speaker comprising:
a driver;
a passive radiator in front of said driver; and
a cabinet storing said driver and covering a rear space of said driver to seal a space between said driver and said passive radiator,
wherein an effective piston area of said passive radiator is larger than an effective piston area of said driver.

2. The speaker according to claim 1,
wherein the effective piston area of said passive radiator is not smaller than twice as large as the effective piston area of said driver.

3. A sound control system comprising
the speaker according to claim 1,
wherein said sound control system detects a signal produced by a sound source, processes the signal by a control filter, and causes said speaker to emit, as a controlled sound, the signal processed by the control filter, so that the controlled sound offers a predetermined effect at a control point.

4. The sound control system according to claim 3,
wherein the control point is positioned close to said speaker,
said sound control system further comprises an effect sensor arranged at the control point to detect an effect of control of said sound control system, and
the control filter adjusts control characteristics of the control filter based on an detected signal of said effect sensor.

5. The sound control system according to claim 4,
wherein the control point is far from said speaker by a distance that is equal to or shorter than a diameter of said driver.

6. The sound control system according to claim 4, further comprising a plurality of effect sensors including said effect sensor,
wherein the control characteristic of the control filter are adjusted based on a signal generated by summing detected signals of said effect sensors.

7. The speaker according to claim 1,
wherein said passive radiator consists of
a plurality of small passive radiators.

8. The sound control system according to claim 3, comprising
a plurality of speakers including said speaker,
wherein said speakers include two speakers adjacent to each other.

9. The sound control system according to claim 8,
wherein said speakers are equipped in a wall.

10. The sound control system according to claim 9,
wherein said driver and said passive radiator in each of said speakers are embedded in the wall, and the wall serves as at least a part of said cabinet in each of said speakers.

11. A wall
in which said speakers included in the sound control system according to claim 10 are embedded.

12. The speaker according to claim 1,
wherein said speaker is embedded in a wall in a house,
the wall separates a to-be-controlled space from an external space outside the to-be-controlled space,
the external space includes an audio apparatus that produces sound,
the to-be-controlled space is a space in which a user listens to the sound,
said speaker is included in a sound control system having an error microphone detecting the sound in the to-be-controlled space,
said driver reproduces the sound so that said speaker emits the reproduced sound to the to-be-controlled space,
the reproduced sound is generated by detecting and converting the sound produced by the audio apparatus into sound having less noise,
a distance from said speaker to the error microphone is a first distance suitable for said speaker including said passive radiator, the first distance being different from a second distance suitable for a speaker without said passive radiator,
the first distance causes the error microphone to be likely to obstruct a movement of the user, and
the second distance causes the error microphone to be unlikely to obstruct the movement of the user.
